(19) United States
(12) Patent Application Publication
(10) Pub. No.: US 2026/0330378 A1
(43) Pub. Date: Oct. 22, 2026

(54) SYSTEM

(71) Applicant: SoftBank Group Corp., Tokyo (JP)

(72) Inventor: Eisuke YAMAZAKI, Tokyo (JP)

(73) Assignee: SoftBank Group Corp., Tokyo (JP)

(21) Appl. No.: 19/650,343

(22) Filed: Apr. 17, 2026

(30) Foreign Application Priority Data
Apr. 21, 2025 (JP) 2025-069977

(51) Int. Cl. G06Q 10/0635; G06F 40/295; G06Q 10/04; G06Q 10/0631; G06Q 10/20; G10L 15/22

(52) U.S. Cl. CPC G06Q 10/0635; G06F 40/295; G06Q 10/04; G06Q 10/06315; G06Q 10/20; G10L 15/22

(57) ABSTRACT

The present invention relates to a system that centrally manages enormous and complex information such as task progress, a dependency relationship, a resource of a person in charge, and communication contents in project management, automatically extracts a bottleneck and a risk by using a generative AI, and automatically generates a specific improvement proposal and an action plan. Furthermore, the system analyzes communication data such as a meeting and a chat, extracts a summary, a decided matter, and an unresolved issue, and performs discussion support and an alert notification in real time, thereby realizing efficiency improvement and optimization of project management and team collaboration.

### CROSS-REFERENCE TO RELATED APPLICATION

The present application claims priority to and incorporates by reference the entire contents of Japanese Patent Application No. 2025-069977 filed in Japan on Apr. 21, 2025.

### BACKGROUND OF THE INVENTION

### 1. Field of the Invention

### The Technology of This Disclosure Relates to a System.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is a complex problem faced by a manager and a team member in execution of a project, such as progress management of a task and optimization of a schedule, grasping of a dependency relationship between tasks, early discovery of and response to a bottleneck and a risk, optimization of resource allocation among persons in charge, and inefficiency of a discussion, delay in information sharing, and delay in minutes creation and decision making in communication such as a meeting and a chat. In a conventional project management tool and communication tool, it has been difficult to manually grasp and organize enormous and complex information such as a progress status and a dependency relationship of a task, a risk factor, and meeting contents, and to quickly derive an appropriate improvement measure and decision making. Therefore, an object of the present invention is to automatically and comprehensively analyze these pieces of information by using a generative AI, realize automatic extraction of a bottleneck and a risk, automatic generation of a specific improvement proposal, summarization of meeting contents, real-time discussion support, and the like, thereby aiming at efficiency improvement and optimization of project management and team collaboration, and improving productivity and quality of an entire project.

### SUMMARY OF THE INVENTION

A means for solving the problem according to the present invention is to configure a system comprising: a task management unit configured to store and manage task information; a communication analysis unit configured to acquire and analyze communication contents such as a meeting and a chat; and an AI integration unit configured to comprehensively analyze a progress status of a project, a dependency relationship between tasks, a person in charge of each task, a deadline, a progress state, and the communication contents based on information obtained from the task management unit and the communication analysis unit by using a generative AI, and execute automatic extraction of a task serving as a bottleneck, prediction of a risk, automatic generation of an improvement proposal, automatic summarization of meeting contents, real-time discussion support, and presentation of these pieces of information to a user, wherein the task management unit stores a name, a person in charge, a deadline, a progress status, and a dependency relationship for a plurality of tasks constituting the project, and monitors changes in the progress status and the dependency relationship in real time; the communication analysis unit acquires communication data such as a meeting and a chat, and extracts a main agenda and a decided matter from minutes and a chat log; and the AI integration unit analyzes the information obtained from the task management unit and the communication analysis unit by using the generative AI, automatically identifies a bottleneck and a risk in project progression, generates a specific improvement proposal and an action plan for these, further summarizes contents of the meeting and the chat, and supports progression of a discussion in real time, thereby realizing efficiency improvement and optimization of project management and team collaboration.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

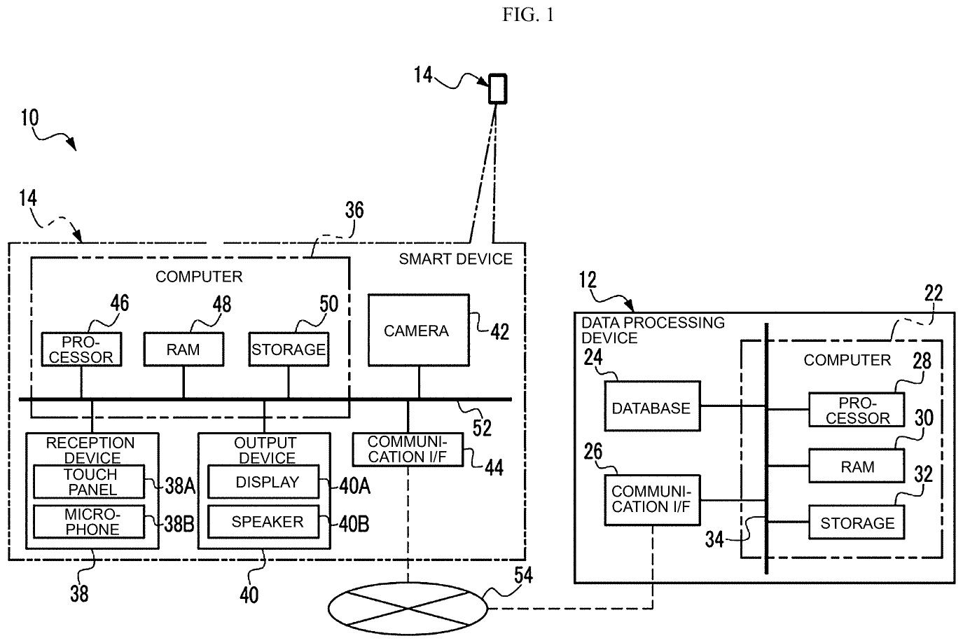

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

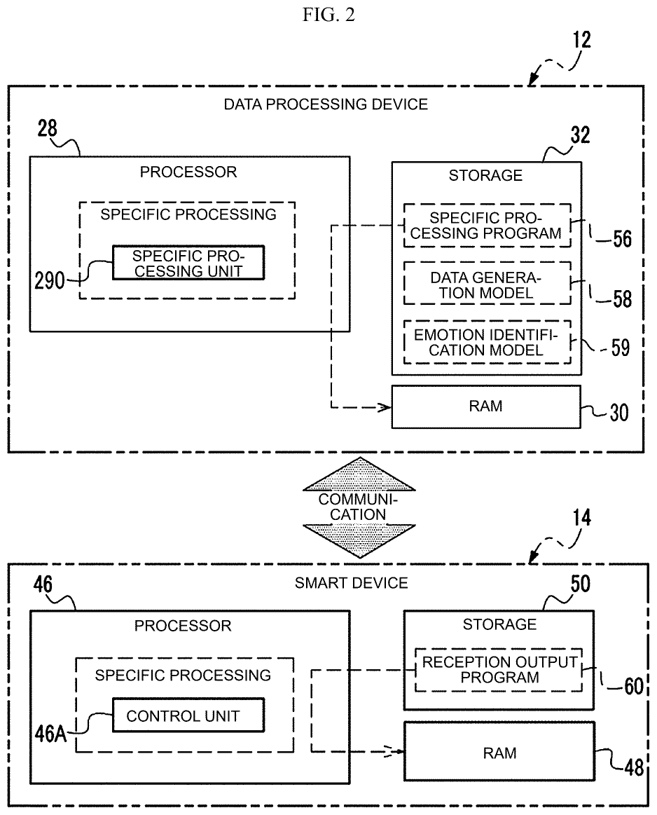

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments of the present invention will be described more specifically and in detail. The system of the present invention adopts a client-server type configuration with a server and a terminal, implements a task management unit, a communication analysis unit, and an AI integration unit on the server side, and provides a user interface unit and a data acquisition/display unit on the terminal side. Hereinafter, functions of each unit, a utilization method of a generative AI, role sharing between the server and the terminal, and specific operation examples will be comprehensively described. Specifically, the present system operates in a distributed computing environment. The present server includes a parallel computing cluster composed of a plurality of computing nodes. The present task management unit, the present communication analysis unit, and the present AI integration unit are containerized as independent microservices, respectively. The present AI integration unit includes a large language model based on a transformer architecture. The present terminal side communicates with the present server using an asynchronous communication protocol. The present system does not simply imitate human mental activities, but executes project management using an unconventional method peculiar to computers, which is a complex matrix operation in a high-dimensional vector space. Thereby, load distribution and scalability improvement of the entire system are achieved. This configuration brings about a technical effect of efficient utilization of computer resources in use cases such as management of a large-scale software development project.

First, the task management unit operates on the server and centrally manages all task information regarding a project. The task information covers a wide variety of items such as a task name, a person in charge, a start date, a deadline, a progress status (unstarted, in progress, completed, delayed, etc.), a dependency relationship, a priority, a required resource, a progress rate, a related document, a past history, a comment, and tagging information. For example, detailed information such as “person in charge: Mr. E”, “deadline: July 10, 2024” “dependent task: design completion”, “priority: high”, “progress rate: 60%”, “related document: design document URL”, and “comment: preparing review materials” is linked to a task called “design review”. Addition, editing, and deletion of a task are performed by an operation from the terminal, and the task management unit of the server immediately updates a database. A dependency relationship between tasks is managed in a graph structure, and a complex dependency relationship such as “requirement definition”

->“design”->“implementation”->“testing”->“release” can also be visualized and managed. Furthermore, a resource status of a person in charge (an operating rate, a concurrent status with other tasks, a vacation schedule, etc.) is also managed for each task, and information such as “person in charge F concurrently handles three tasks with an operating rate of 80% this week” is also recorded. Specifically, the present task management unit persists the task information using a relational database or a graph database. The present task management unit expands the dependency relationship between tasks on a memory as a directed acyclic graph. The present task management unit encodes attribute information of each task as a feature vector on a multidimensional vector space. For example, the present task management unit concatenates an identifier of a person in charge, a timestamp of a deadline, and a floating-point number of a progress rate to generate a 256-dimensional numerical vector. The present task management unit learns a structure of the directed acyclic graph using a graph neural network. An input to the present task management unit is a group of numerical vectors indicating attributes of tasks. Specific examples of the input include a progress rate of 0.6 and an integer value of 1 indicating a priority. An output from the present task management unit is a latent representation vector of each node. A specific example of the output includes a continuous value from 0.0 to 1.0 indicating a degree of relevance between tasks. The present task management unit uses the output vector as an index for subsequent search processing. Thereby, high-speed search of a complex dependency relationship and real-time detection of resource conflict become possible. This configuration brings about a technical effect of a dramatic improvement in data search speed in use cases such as process management of a construction project involving hundreds of people.

The communication analysis unit operates on the server and automatically acquires various communication data such as a meeting, a chat, an email, an SNS, and a voice call from the terminal and an external service.

For example, voice data of a web meeting held on the terminal is transmitted to the server in real time and converted into text by a voice recognition engine. A message log is automatically collected from a chat tool and an email service by API linkage. Group posts and comments on the SNS are also targeted. For these massive amounts of communication data, the generative AI automatically extracts, for example, a “main agenda of a meeting”, a “decided matter”, an “unresolved issue”, a “next action”
a “conflict of opinions between persons in charge”, a “remark regarding a risk”, a “progress report”, “raising of an issue”, a “request”
an “intention indication of approval or rejection”, and the like by using natural language processing. For example, specific information such as “in today's meeting, a delay of task A was reported, and addition of a person in charge of task B was decided”, “Mr. C requested a specification change of task D in a chat”, and “Mr. E reported progress of task F by email” is extracted. Furthermore, speaker separation and utterance frequency analysis are also performed from the voice data of the meeting, and a communication bias such as “Mr. G accounts for 40% of the entire utterances” and “Mr. H has few utterances” can also be detected. Specifically, the present communication analysis unit extracts Mel-frequency cepstral coefficients for the voice data to generate an acoustic feature tensor. The present communication analysis unit generates text data using a voice recognition model combining a convolutional neural network and a long short-term memory network. The present communication analysis unit tokenizes the text data and converts it into a word embedding vector. The present communication analysis unit inputs the word embedding vector to a large language model. An input to the present large language model is a time-series array of up to 512 tokens. Specific examples of the input include a text token sequence such as task A is delayed, I want to change the specification of task B, and the like. An output from the present large language model is a probability distribution of a named entity label for each token. Specific examples of the output include a probability of 0.95 for a target task label for task A, a probability of 0.88 for a risk label for being delayed, and the like. The present communication analysis unit applies a softmax function to the output probability distribution, and determines a threshold value of 0.8 or more as a valid extraction result. The present communication analysis unit converts the extraction result into structured data and transmits it to the subsequent present AI integration unit. Thereby, highly accurate semantic extraction from unstructured data and objective risk detection excluding human subjectivity become possible. This configuration brings about a technical effect of improving information extraction accuracy in use cases such as communication monitoring of an agile development team under a remote work environment.

The AI integration unit operates on the server and comprehensively analyzes all information collected from the task management unit and the communication analysis unit by using the generative AI. The generative AI analyzes a progress status of a task, a dependency relationship, a resource status of a person in charge, communication contents, a past history, external benchmark data, and the like in a multivariate manner, and automatically extracts a bottleneck and a risk of the entire project. For example, it identifies complex factors such as “a delay of a design task hinders a start of an implementation task”, “person in charge I concurrently handles a plurality of tasks and resources are tight”, and “it was found in a meeting that a specification of task J is undetermined”. For these factors, the generative AI automatically generates a specific improvement proposal and an action plan such as “increase the number of persons in charge of the design task”, “set a specification determination meeting for task J early”, and “reallocate resources of person in charge I and add a person in charge of task K” while referring to solution examples of past similar projects and external best practices. Furthermore, the generative AI can also execute automatic resetting of a priority and a deadline of a task, automatic assignment of a person in charge, automatic alert issuance at the time of a progress delay, automatic escalation at the time of risk occurrence, and the like. Specifically, the present AI integration unit includes an integrated neural network that processes multimodal input data. The present AI integration unit combines graph structure data from the present task management unit and structured text data from the present communication analysis unit to generate a high-dimensional integrated feature tensor. The present AI integration unit calculates a hidden correlation between tasks using a self-attention mechanism. An input to the present AI integration unit is a 1024-dimensional integrated feature vector. Specific examples of the input include a numerical array of a task progress rate, a numerical array of an operating rate of a person in charge, and an embedding vector of an extracted risk keyword. An output from the present AI integration unit is a risk score for each task and a category label of a recommended action. Specific examples of the output include a risk score of 0.92 for task J, a probability of 0.85 for increasing the number of persons in charge which is a recommended action, and the like. When the risk score exceeds a predetermined threshold value, the present AI integration unit automatically activates an alert generation module. The present AI integration unit learns past project success examples as rewards using a reinforcement learning algorithm. Thereby, entanglement of complex factors unrecognizable by humans is mathematically unraveled, and optimal resource allocation is calculated at high speed. This configuration brings about a technical effect of speeding up decision-making and reducing errors in use cases such as promotion of a company-wide digital transformation project spanning a plurality of departments.

In addition, the AI integration unit utilizes the generative AI in real time even during progression of a meeting and a chat, and when detecting a digression of a discussion or existence of an unresolved issue, automatically notifies the terminal of advice and a reminder such as “please confirm the unresolved issue before transition to a next agenda”, “there is a similar case in the past for this discussion, and there is an example solved by adjustment between persons in charge”, and “a progress report of task L is missing”. For example, when an agenda deviates during a meeting, the AI supports facilitation in real time by saying “please prompt to return to the original agenda”. Furthermore, after the meeting ends, minutes, a summary, a decided matter, a next action, an unresolved issue list, and the like automatically generated by the AI are distributed to the terminal, and participants can confirm contents and add corrections and supplements as necessary. The unresolved issue and the next action extracted by the AI are automatically registered in the task management unit and centrally managed as project tasks. Specifically, the present AI integration unit executes real-time inference using a stream data processing engine. The present AI integration unit continuously acquires utterance text tokens for the latest 5 minutes by a sliding window method. The present AI integration unit calculates a cosine similarity between the acquired text tokens and an embedding vector of a preset agenda. The present AI integration unit determines a digression of a discussion when a state in which the cosine similarity falls below a predetermined threshold value continues for a certain period of time. An input to the present AI integration unit is a time-series tensor of utterance text updated in real time. Specific examples of the input include a non-business-related utterance vector such as about yesterday's baseball game. An output from the present AI integration unit is a binary flag indicating a necessity of intervention and a text character string of a generated intervention message. Specific examples of the output include a binary flag 1 and a message character string saying let's return to agenda item 2. When the binary flag is 1, the present AI integration unit transmits a push notification to the user interface unit of the present terminal via a bidirectional communication protocol. The present AI integration unit activates an encoder-decoder model for summary generation triggered by the end of the meeting. Thereby, productivity improvement of the meeting and reduction of rework due to prevention of omission of a decided matter become possible. This configuration brings about a technical effect of reducing a communication load and improving real-time processing in use cases such as automatic facilitation of an online regular meeting in which multinational members participate.

On the terminal side, an interface is provided for a user to perform input/editing of task information, execution of a meeting and a chat, browsing of a proposal and a summary by the AI, approval/rejection of an action plan, visualization of a progress status, adjustment of resource allocation, confirmation/correction of minutes, and the like. For example, on a dashboard screen of the terminal, a progress status of an entire project, a state of each task, an alert of a bottleneck and a risk, an improvement proposal by the AI, a summary of a meeting, an unresolved issue list, and the like can be confirmed at a glance. The progress status of the task is displayed in a Gantt chart or Kanban board format, and a state change of the task and assignment of a person in charge are possible by drag and drop. Regarding the improvement proposal generated by the AI, the user can approve/reject it with one click, and the approved proposal is automatically reflected in the task management unit and the resource allocation. Specifically, the present terminal draws complex screen components at high speed by hardware acceleration using a graphical processing unit. The present terminal adopts a single-page application architecture to minimize communication overhead with the server. The present terminal holds structured data received from the server in a local in-memory state management store. The present terminal detects coordinate data of a drag-and-drop operation by the user, and fires a change event of a task state. The present terminal generates an asynchronous communication request based on the change event, and transmits it to an application programming interface of the server. Upon receiving an approval operation for the improvement proposal by the AI, the present terminal transmits a payload including an approval flag to the server. The present terminal applies an optimistic update method of updating a local screen display in advance without waiting for a response from the server. Thereby, an influence of a network delay is concealed, and a seamless and highly responsive operation experience is provided to the user. This configuration brings about a technical effect of improving a drawing speed of a user interface and eliminating an operation delay in use cases such as a real-time progress report and task adjustment from a construction site using a mobile terminal.

Furthermore, for example, in an initial stage of a project, identification of tasks, setting of a dependency relationship, assignment of a person in charge, and setting of a deadline are performed from the terminal, and registered in the task management unit of the server. During progression of the project, the person in charge updates a progress status from the terminal at any time, and contents of a meeting and a chat are also transmitted from the terminal to the server. The AI integration unit on the server analyzes these pieces of information in real time, generates an alert such as “a plurality of tasks scheduled to be completed this week are delayed”, “resources of person in charge M are excessively consumed”, and “a specification of task N is undetermined and a risk is high”, and a specific action plan such as “a priority of task O should be raised”, “additional support should be assigned to person in charge P”, and “a deadline of task Q should be reset”, and notifies the terminal. Specifically, the present system executes continuous data collection and fine-tuning of a model throughout an entire life cycle of the project. The present server stores a task group input in the initial stage in a graph database as an initial node set. The present AI integration unit predicts a scheduled completion date of a task as a probability distribution using a time-series prediction model such as an autoregressive integrated moving average model. An input to the present AI integration unit is a time-series numerical array indicating a past task consumption speed. Specific examples of the input include an integer array indicating the number of daily task completions for the past 14 days. An output from the present AI integration unit is a continuous value of a task completion probability on a specific future date. A specific example of the output includes a numerical value of a completion probability of 0.35 by the end of this week. When the completion probability falls below a predetermined threshold value, the present AI integration unit determines that there is a delay risk, and branches to alert generation processing. The present AI integration unit searches for a reallocation pattern of a person in charge using a resource optimization algorithm such as linear programming. Thereby, data-driven project prediction independent of rules of thumb and proactive risk avoidance become possible. This configuration brings about a technical effect of improving prediction accuracy and optimally allocating computing resources in use cases such as milestone management and dynamic reallocation of resources in a new product development project.

In addition, for example, after a meeting ends, minutes and a summary automatically generated by the AI are displayed on the terminal, and participants can confirm contents and add corrections and supplements as necessary. An unresolved issue and a next action detected by the AI during the meeting are also automatically registered in the task management unit and managed as tasks of a project. Furthermore, the AI analyzes a history of past meetings and chats, performs trend analysis such as “progress of task R has not been reported in the past three meetings” and “a discussion regarding task S repeatedly occurs”, and can utilize it for improvement of project operation. Specifically, the present AI integration unit records a user's correction operation on generated minutes text as difference data. The present AI integration unit uses this difference data as teacher data, and updates a weight parameter of a summary generation model by a backpropagation method. The present AI integration unit extracts a latent topic distribution from past meeting records using a topic modeling method such as a latent Dirichlet allocation method. An input to the present AI integration unit is a document vector combining texts of a plurality of past meetings. A specific example of the input includes a 10,000-dimensional sparse matrix vector generated from meeting records for the past one month. An output from the present AI integration unit is an appearance probability distribution of each topic and a list of feature words constituting the topic. A specific example of the output includes an appearance probability of 0.6 for a topic having feature words such as task S and specification change. When an appearance probability of a specific topic maintains a high value over a plurality of meetings, the present AI integration unit flags the topic as a stagnant issue. Thereby, continuous accuracy improvement of a model through user feedback and early discovery of a potential project stagnation factor become possible. This configuration brings about a technical effect of improving inference accuracy of a machine learning model in use cases such as identification of a chronic issue and process improvement in a long-term system maintenance and operation project.

As described above, the system of the present invention realizes the task management unit, the communication analysis unit, and the AI integration unit on the server, and the terminal is configured to be responsible for a user interface and a data acquisition/display function, thereby realizing efficiency improvement and optimization of project management and team collaboration utilizing the generative AI. The generative AI analyzes massive and complex information such as task progress, a dependency relationship, resource allocation, and communication contents in real time, and plays an indispensable role in all scenes of project operation, such as automatic extraction of a bottleneck and a risk, automatic generation of a specific improvement proposal, summarization of meeting contents and real-time discussion support, trend analysis of past data, detection of a communication bias between persons in charge, automatic alert issuance at the time of a progress delay, and automatic escalation at the time of risk occurrence, enabling advanced project management and optimization of collaboration that could not be realized by conventional manual management or a simple automation tool. Specifically, the present system does not simply imitate human mental activities, but executes project management using an unconventional method peculiar to computers, which is a complex matrix operation and probabilistic inference in a high-dimensional vector space. The present system simultaneously processes millions of pieces of task data and hundreds of millions of tokens of communication logs in a parallel processing pipeline. The present system adopts a binary serialization format in data transfer between respective modules to reduce a communication bandwidth to the utmost limit. The present system speeds up inference processing of an AI model using a tensor operation core of a graphical processing unit. The present system uses a cross-entropy error as a loss function, and optimizes the model by a gradient descent optimization algorithm. Thereby, efficient utilization of computer resources and a dramatic improvement in inference accuracy in an atypical and dynamic project environment that cannot be handled by a conventional rule-based system become possible. This configuration brings about a technical effect of improving a processing speed of the entire system and reducing a communication load in use cases such as construction and operation management of a large-scale cloud infrastructure by a globally distributed development team of thousands of people.

### System Configuration

The system according to the present embodiment comprises a task management unit, a communication analysis unit, an AI integration unit, a user interface unit, and a data acquisition/display unit. The task management unit has a function of centrally storing and managing a plurality of pieces of task information constituting a project, and records, for example, a task name, a person in charge, a start date, a deadline, a progress status, a dependency relationship, a priority, a required resource, a progress rate, a related document, a past history, a comment, tagging information, and the like in a database. The task management unit receives addition, editing, and deletion of a task, assignment of a person in charge, change of a deadline, update of a progress rate, and the like in real time through an input from a terminal and API linkage with an external tool, and comprehensively manages all task information necessary for project operation, such as an operation of changing progress of a “design review” task from 60% to 80%, an operation of changing a person in charge of an “implementation” task from Mr. A to Mr. B, registration of a logical relationship that a “design” task cannot be started unless a “requirements definition” task is completed as a dependency relationship of a task, and management of information such as “person in charge C concurrently performs three tasks at an operating rate of 80% this week” as a resource status of a person in charge. Specifically, the present system is implemented as a distributed system based on a microservices architecture. The present task management unit manages a task state updated at a high frequency with a latency in milliseconds by using an in-memory data grid. The present task management unit persists an update history of a task as an append-only log by using an event sourcing pattern. The present task management unit comprises a preprocessing pipeline that normalizes an attribute of each task and converts the attribute into a feature quantity matrix processable by a machine learning model. The present task management unit applies one-hot encoding to a categorical variable such as a name of a person in charge, and applies min-max scaling to a numerical variable such as a progress rate. The present task management unit streaming-transfers the data having undergone these preprocessings to the subsequent present AI integration unit. This enables maintenance of data consistency under a large-scale simultaneous access environment and speed-up of input data generation to an AI model. This configuration brings about technical effects of improvement of data management and efficiency improvement of processing in a use case such as strict task tracking and audit log management of a large-scale system integration project in a financial institution.

The communication analysis unit has a function of automatically acquiring various communication data such as a meeting, a chat, an email, an SNS, and a voice call from a terminal and an external service, and analyzing these pieces of data. For example, this includes a process of transmitting voice data of a web meeting to a server in real time and converting the voice data into text by a voice recognition engine, a process of automatically collecting a message log from a chat tool and an email service by API linkage, a process of acquiring a group post and a comment of an SNS, a process of performing speaker diarization and utterance frequency analysis from voice data of a meeting, and the like. The communication analysis unit utilizes a generative AI to automatically extract, for example, a “main agenda of a meeting”
“decided matter”, an “unresolved issue”, a “next action”, an “opinion conflict between persons in charge”, a “remark regarding a risk”, a “progress report”, “raising of an issue”, a “request”, an “intention indication of approval or rejection”, and the like, and extracts specific information such as “in today's meeting, a delay of task A was reported, and addition of a person in charge of task B was decided”, “Mr. C requested a specification change of task D in a chat”, “Mr. E reported progress of task F by email”, “Mr. G accounts for 40% of utterances in a meeting”, and “Mr. H has few utterances”. Specifically, the present communication analysis unit receives data via a distributed messaging system that integrates multi-channel data streams. The present communication analysis unit applies an acoustic model combining a hidden Markov model and a deep neural network to voice data to estimate a phoneme sequence. The present communication analysis unit extracts a fixed-dimensional feature vector from a voice signal for speaker diarization. The present communication analysis unit applies a Gaussian mixture model to the extracted vector to generate a cluster for each speaker. An input to the present communication analysis unit is a pulse code modulation voice waveform tensor with a sampling rate of 16 kilohertz. As a specific example of the input, 5-second voice waveform data in which a plurality of persons are uttering simultaneously is cited. An output from the present communication analysis unit is a set of a time stamp, a speaker identifier, and a text-converted character string. As a specific example of the output, character string data that task A of speaker 1 is delayed at a time point of 15 seconds from the start is cited. The present communication analysis unit inputs the extracted text data to a natural language processing model, and executes dependency parsing and named entity recognition. This enables highly accurate information extraction from voice data in a noisy real environment and integrated understanding of multimodal data. This configuration brings about technical effects of improvement of voice recognition accuracy and automation of processing in a use case such as real-time analysis of call contents between a customer and an operator and escalation determination in a call center.

The AI integration unit has a function of comprehensively analyzing all information collected from the task management unit and the communication analysis unit by using a generative AI. The AI integration unit analyzes a progress status of a task, a dependency relationship, a resource status of a person in charge, communication contents, a past history, external benchmark data, and the like in a multivariate manner, and automatically extracts a bottleneck and a risk of the entire project. For example, the AI integration unit specifies a complex factor such as “a delay of a design task hinders a start of an implementation task”, “person in charge I concurrently performs a plurality of tasks and resources are tight”, and “it was found in a meeting that a specification of task J is undetermined”. The AI integration unit automatically generates a specific improvement proposal and an action plan such as “increasing the number of persons in charge of the design task”, “setting a specification determination meeting for task J early”, and “reallocating resources of person in charge I and adding a person in charge of task K” for these factors while referring to a solution example of a similar project in the past and an external best practice. Furthermore, automatic resetting of a priority and a deadline of a task, automatic assignment of a person in charge, automatic alert issuance at the time of a progress delay, automatic escalation at the time of risk occurrence, and the like can also be executed. The AI integration unit utilizes the generative AI in real time even during progression of a meeting and a chat, and when detecting a digression of a discussion or existence of an unresolved issue, automatically notifies a terminal of advice and a reminder such as “please confirm the unresolved issue before transition to a next agenda”, “there is a similar case in the past for this discussion, and there is an example solved by adjustment between persons in charge”, and “a progress report of task L is missing”. After the meeting ends, minutes, a summary, a decided matter, a next action, an unresolved issue list, and the like automatically generated by the AI are distributed to the terminal, and a participant can confirm contents and add a correction and a supplement as necessary. The unresolved issue and the next action extracted by the AI are automatically registered in the task management unit and centrally managed as a project task. Specifically, the present AI integration unit constructs a knowledge graph, and expresses a relationship between entities such as a task, a person in charge, utterance contents, and a risk factor on a vector space. The present AI integration unit updates a node feature quantity on the knowledge graph by using a graph convolutional network. An input to the present AI integration unit is a node feature quantity matrix and an adjacency matrix. As a specific example of the input, graph structure data in which a task node, a person in charge node, and a meeting utterance node are connected by an edge is cited. An output from the present AI integration unit is a latent representation vector of each node and a prediction probability of an edge. As a specific example of the output, a probability of 0.95 that an edge exists between a task J node and a specification undetermined node is cited. The present AI integration unit specifies a potential bottleneck based on this prediction probability. The present AI integration unit embeds the specified bottleneck information into a prompt template, inputs the prompt template to a large language model, and generates an improvement proposal in a natural language. The present AI integration unit scores validity of the proposal for the generated proposal text by using a reinforcement learning from human feedback method. The present AI integration unit executes a filtering process of transmitting only a proposal whose score exceeds a predetermined threshold to the terminal. This enables advanced inference by semantic integration of heterogeneous data and highly reliable proposal generation suppressing hallucination. This configuration brings about technical effects of improvement of inference accuracy and reduction of false detection in a use case such as early discovery of a parts supply delay risk and automatic proposal of an alternative procurement route in complex supply chain management.

The user interface unit operates on the terminal, and provides an interface for the user to perform input/editing of task information, execution of a meeting and a chat, browsing of a proposal and a summary by the AI, approval/rejection of an action plan, visualization of a progress status, adjustment of resource allocation, confirmation/correction of minutes, and the like. For example, on a dashboard screen of the terminal, a progress status of an entire project, a state of each task, an alert of a bottleneck and a risk, an improvement proposal by the AI, a summary of a meeting, an unresolved issue list, and the like can be confirmed at a glance. The progress status of the task is displayed in a Gantt chart or Kanban board format, and a state change of the task and assignment of a person in charge are possible by drag and drop. Regarding the improvement proposal generated by the AI, the user can approve/reject the improvement proposal with one click, and the approved proposal is automatically reflected in the task management unit and the resource allocation. Specifically, the present user interface unit operates on a browser with performance close to that of a native application by using a WebAssembly technology. The present user interface unit minimizes redrawing of a screen by using a virtual document object model algorithm. When receiving the improvement proposal from the AI, the present user interface unit executes a highlight process using a cascading style sheet animation on a corresponding task element on the screen. The present user interface unit captures a click event of the user, and generates a data payload including a Boolean value indicating a state of approval or rejection. The present user interface unit transmits the generated payload to the server by using an asynchronous communication interface. The present user interface unit updates a local data store and immediately changes a length and a color of a bar of the Gantt chart before receiving a processing completion response from the server. The present user interface unit queues an operation history in a local storage at the time of network disconnection, and executes a synchronization process in the background at the time of reconnection. This achieves reduction of a cognitive load of the user and improvement of robustness capable of continuing work even under an offline environment. This configuration brings about technical effects of improvement of a screen drawing speed and reduction of a communication waiting time in a use case such as confirmation of a work instruction and actual result input using a tablet terminal in a construction site and a plant facility where a communication environment is unstable.

The data acquisition/display unit is responsible for data transmission from the terminal to the server and data reception/display from the server to the terminal. For example, this includes a process of transmitting meeting voice and a chat log to the server in real time, a process of distributing minutes, a summary, an action plan, an alert, a trend analysis result, and the like generated by the AI to the terminal so that the user can immediately browse and confirm them, a process of reflecting change contents of task progress and resource allocation to the server, a data linkage process with an external tool, and the like. Specifically, the present data acquisition/display unit establishes a bidirectional communication protocol and maintains a persistent connection. The present data acquisition/display unit converts an analog voice signal acquired from a microphone device of the terminal into digital data by using an analog-to-digital converter. The present data acquisition/display unit divides the digital voice data into a predetermined chunk size such as 20 milliseconds, and streaming-transmits the digital voice data to the server as a voice packet. The present data acquisition/display unit applies a lossless compression algorithm to a payload of transmission data to reduce a communication data amount. The present data acquisition/display unit listens to a communication request from a webhook endpoint of an external tool such as a source code management system. The present data acquisition/display unit extracts a specific key-value pair such as a commit hash and a build status from the received payload, and converts the specific key-value pair into an internal data format. When an importance flag is included in alert data received from the server, the present data acquisition/display unit calls a native notification function of an operating system to display a pop-up notification. This enables guarantee of real-time property and elimination of an information silo by seamless data integration between heterogeneous systems. This configuration brings about technical effects of saving of a communication band and reduction of a delay of data processing in a use case such as integrated monitoring of a series of pipeline statuses from a commit of a source code to an automatic test in software development.

As a specific example of a prompt sentence to be read by the generative AI when implementing the present invention, for example, “Please analyze the following task information and communication log, specify a bottleneck of a progress delay and resource tightness, and generate a specific improvement proposal. Task information: design task, person in charge A, deadline July 10, progress 60%, dependent task: requirements definition. Communication log: person in charge A complains of a resource shortage in a meeting.”, “Please summarize the following meeting voice text, and extract a main agenda, a decided matter, an unresolved issue, and a next action.

Meeting text: in today's meeting, it was discussed that progress of task B is delayed, and it was decided to raise a priority of task C.”, “Please extract a remark regarding a risk and an issue from the following chat log, and link the remark to a related task. Chat log: Mr. D requests a specification change of task E. Mr. F reports a progress delay of task G.”, and the like are cited. Furthermore, an advanced prompt such as “Please compare a past project history and current task progress, predict a risk that may occur in the future, and present a countermeasure plan.” can also be utilized. Specifically, the present system controls an output of a large language model to a specific format by using a prompt engineering technology. The present system adds a system role to the head of the prompt sentence to limit an inference context of the model. The present system adopts a method of including several examples of expected input/output pairs in the prompt to improve accuracy of the output. An input prompt to the present system is configured as an array of text character strings. As a specific example of the input, text data in which structured task data and an instruction sentence in a natural language are combined is cited. An output from the present system is a structured text strictly following a designated schema. As a specific example of the output, a data structure having a bottleneck as a key and a resource shortage of person in charge A as a value is cited. The present system parses the output data structure, and utilizes the data structure as an input parameter of a subsequent database update process and screen drawing process. When the number of tokens of the prompt exceeds a limit of the model, the present system divides the text for each semantic paragraph, and executes a summarization process stepwise by a MapReduce method. This enables control of a non-deterministic output of the large language model and generation of stable structured data capable of withstanding inter-system linkage. This configuration brings about technical effects of improvement of stability of data processing and reduction of an error rate in a use case such as a customer support operation of automatically analyzing a claim text from an atypical customer, automatically generating a corresponding task, and routing the task to a department in charge.

In this way, the system according to the present embodiment comprises the task management unit, the communication analysis unit, the AI integration unit, the user interface unit, and the data acquisition/display unit, and each unit cooperates to realize efficiency improvement and optimization of project management and team collaboration, enabling advanced information analysis and decision-making support with the generative AI at the core. Specifically, the present system adopts a cloud-native architecture in which each unit is managed as an independent container on a container orchestration system. The present system performs communication between the respective containers via a service mesh to ensure traffic routing, encryption, and observability. The present system arranges a load balancer for an inference endpoint of the generative AI model, and executes auto-scaling in response to a rapid increase in requests. The present system continuously collects feedback such as user approval and correction for an inference result of the AI model, and accumulates the feedback in a data lake. The present system periodically executes parameter-efficient fine-tuning of the AI model by using the accumulated feedback data, and causes the model to learn project management know-how peculiar to an organization. When updating a weight parameter of the model, the present system applies gradient clipping to maintain stability of learning. This enables securing of high availability and scalability of the system, and realization of a self-evolving system in which inference accuracy improves by adapting to a context of the organization as operation continues. This configuration brings about technical effects of improvement of a system operating rate and optimization of learning efficiency in a use case such as promotion of company-wide cross-sectional knowledge management and business process standardization in a global company having tens of thousands of employees.

### Implementation Steps

Step 1: Registration and Management of Task Information At the start of a project, all pieces of task information constituting the project are input by using the user interface unit of the terminal, and registered in the task management unit of the server. The task information includes a task name, a person in charge, a start date, a deadline, a progress status, a dependency relationship, a priority, a required resource, a progress rate, a related document, a past history, a comment, tagging information, and the like. For example, detailed information such as “person in charge: Mr. E”, “deadline: July 10, 2024”

“dependent task: design completion”, “priority: high”, “progress rate: 60%”, “related document: design document URL”, and “comment: preparing review materials” is registered in a “design review” task. Addition, editing, and deletion of a task, assignment of a person in charge, change of a deadline, update of a progress rate, and the like are also performed from the terminal at any time, and the task management unit of the server immediately updates the database. Specifically, in this step, the present terminal serializes input data of the user into a structured payload, and transmits the structured payload to the present server via an encrypted communication protocol. The task management unit of the present server executes input validation on the received payload, and checks a mismatch of a data type and a lack of a required item. The present task management unit inserts or updates the data having passed the validation into a normalized table group of a relational database. The present task management unit performs transaction control of the database to prevent data inconsistency due to simultaneous updates from a plurality of users. When registration and update of the task are completed, the present task management unit issues an event message to a message broker. The present task management unit asynchronously updates an index of a distributed full-text search engine triggered by this event message. This enables maintenance of consistency of enormous task data in a large-scale project and construction of a foundation for high-speed search and aggregation processing. This configuration brings about technical effects of avoidance of data writing conflict and improvement of a search speed in a use case such as strict configuration management of tens of thousands of work breakdown structures in large-scale plant construction involving a large number of subcontractors.
Step 2: Acquisition and Accumulation of Communication Data Communication data such as a meeting, a chat, an email, an SNS, and a voice call is automatically acquired from the terminal and an external service, and accumulated in the communication analysis unit of the server.

For example, voice data of a web meeting is transmitted to the server in real time and converted into text by a voice recognition engine. A message log is automatically collected from a chat tool and an email service by API linkage, and a group post and a comment of an SNS are also targeted. Speaker diarization and utterance frequency analysis are also performed from the voice data of the meeting, and information such as “Mr. G accounts for 40% of utterances” and “Mr. H has few utterances” is also extracted. Specifically, in this step, the present communication analysis unit securely accesses an application programming interface of the external service by using an authorization protocol, and acquires an access token. The present communication analysis unit acquires a new message log as array data by periodically performing polling using the acquired token or receiving a webhook. The present communication analysis unit performs word segmentation on the acquired text data by using a morphological analysis engine, and executes natural language preprocessing such as removal of a stop word and stemming. The present communication analysis unit applies a short-time Fourier transform to the voice data to generate a spectrogram image. An input to the present communication analysis unit is this spectrogram image tensor. As a specific example of the input, a two-dimensional numerical array having a time axis and a frequency axis is cited. An output from the present communication analysis unit is a posterior probability distribution of a phoneme in each time frame. As a specific example of the output, a probability of 0.9 of being a specific vowel in a specific time frame is cited. The present communication analysis unit searches for the most probable phoneme sequence by using a Viterbi algorithm, and decodes the phoneme sequence into a text character string. The present communication analysis unit stores the extracted text and speaker metadata in a time-series database using a time stamp as a key. This enables structuring of multimodal unstructured data and automatic generation of a high-quality data set for subsequent AI analysis. This configuration brings about technical effects of automation of data preprocessing and improvement of analysis accuracy in a use case such as real-time monitoring of all calls and chats for compliance violation detection on a financial trading floor.
Step 3: Task and communication analysis by generative AI. The AI integration unit of the server inputs all information collected from the task management unit and the communication analysis unit into the generative AI, and comprehensively analyzes the information. The generative AI analyzes a progress status of a task, a dependency relationship, a resource status of a person in charge, communication contents, a past history, external benchmark data, and the like in a multivariate manner, and automatically extracts a bottleneck and a risk of the entire project. For example, the generative AI specifies complex factors such as “a delay of a design task hinders a start of an implementation task”, “a person in charge I concurrently holds a plurality of tasks and resources are tight”, and “it is found in a meeting that a specification of a J task is undetermined”. Specific examples of a prompt sentence to be read by the generative AI include “Please analyze the following task information and communication log, specify a bottleneck of a progress delay and resource tightness, and generate a specific improvement proposal. Task information: design task, person in charge A, deadline July 10, progress 60%, dependent task: requirement definition. Communication log: person in charge A complains about a lack of resources in a meeting.”
and “Please summarize the following meeting voice text and extract a main agenda, a decided matter, an unresolved issue, and a next action. Meeting text: In today's meeting, it was discussed that progress of a B task is delayed, and it was decided to raise a priority of a C task.” Specifically, in this step, the AI integration unit uses a multimodal encoder for mapping heterogeneous data to a common latent space. The AI integration unit encodes numerical data of a task such as a progress rate by a multilayer perceptron, and encodes text data by a transformer encoder. The AI integration unit combines these encoded feature vectors, and calculates an interaction between data by using a cross-attention mechanism. An input to the AI integration unit is a combined high-dimensional feature amount tensor. As a specific example of the input, a 512-dimensional tensor in which a progress vector of a task A and an embedding vector of a remark text of a person in charge A are combined is cited. An output from the AI integration unit is an array of probability scores for each risk category such as a schedule delay and a resource shortage. As a specific example of the output, a numerical array of a schedule delay probability of 0.85 and a resource shortage probability of 0.92 is cited. The AI integration unit inputs these probability scores into a logistic regression classifier, and performs binary determination on presence or absence of a final bottleneck. The AI integration unit dynamically constructs an input prompt to a large language model based on a determination result, and gives the input prompt as a context. Thereby, highly accurate prediction of a risk exceeding human intuition becomes possible by fusion of quantitative task data and qualitative communication data. This configuration brings about technical effects of improvement in generalization performance of a prediction model and calculation efficiency improvement in a use case such as integrated risk evaluation of each progress and issue of legal affairs and financial affairs in a large-scale corporate acquisition project.
Step 4: Automatic generation of an improvement proposal and an action plan by generative AI. The AI integration unit automatically generates a specific improvement proposal and an action plan for the extracted bottleneck and risk by using the generative AI while referring to a solution example of a past similar project and an external best practice. For example, the AI integration unit generates a proposal such as “increase the number of persons in charge of a design task”, “set a specification confirmation meeting of a J task early”, and “reallocate resources of a person in charge I and add a person in charge of a K task”. Specific examples of a prompt sentence to be read by the generative AI include “Please generate an optimal improvement proposal and action plan with reference to the following project situation and past solution example. Project situation: design task delay, person in charge resource tightness, J task specification undetermined. Past example: a design task delay was solved by increasing the number of persons in charge.” Specifically, in this step, the AI integration unit adopts a retrieval-augmented generation architecture. The AI integration unit converts the extracted bottleneck information into a query vector, and executes an approximate nearest neighbor search on a vector database. An input to the AI integration unit is a 768-dimensional query vector generated from the bottleneck information. As a specific example of the input, a numerical vector encoding a state of a design task delay and resource tightness is cited. An output from the AI integration unit is a list of a plurality of top past solution example documents having high similarity in a vector space. As a specific example of the output, text data of an example of increasing the number of persons in charge in a past project having a similarity score of 0.88 is cited. The AI integration unit combines the retrieved past example text and the current project situation into a prompt template, and inputs the prompt template into a large language model. The AI integration unit generates a token sequence with the highest likelihood by using a beam search algorithm in a decoder part of the large language model. The AI integration unit outputs the generated action plan in a structured data format, calls an interface of the task management unit, and automatically registers the action plan as a new task. Thereby, automatic derivation of an executable and context-specific concrete solution becomes possible by combining dynamic calling of past organizational memory and inference capability of the generative AI. This configuration brings about technical effects of shortening of a problem solving time and improvement in validity of inference in a use case such as automatic generation of a recovery procedure based on a past response history and task assignment to an engineer in charge when a failure occurs in an information technology infrastructure.
Step 5: Real-time support and summarization of a meeting and a chat by generative AI. The AI integration unit utilizes the generative AI in real time even during progression of a meeting and a chat, and when detecting a digression of a discussion or existence of an unresolved issue, automatically notifies the terminal of advice and a reminder such as “please confirm the unresolved issue before transition to a next agenda”, “there is a similar case in the past for this discussion, and there is an example solved by adjustment between persons in charge”, and “a progress report of an L task is missing”. After the meeting ends, minutes, a summary, a decided matter, a next action, an unresolved issue list, and the like automatically generated by the AI are distributed to the terminal, and a participant can confirm contents and add a correction or a supplement as necessary. Specific examples of a prompt sentence to be read by the generative AI include “Please analyze the following meeting voice text in real time, immediately issue an alert when detecting a digression of a discussion or an unresolved issue, and automatically generate a summary and a decided matter after the meeting ends. Meeting text: . . . ” Specifically, the AI integration unit includes a transformer architecture based on a large language model. The AI integration unit converts voice recognition text data acquired in real time into a time-series word embedding vector. The AI integration unit receives this word embedding vector as 512-dimensional tensor data at an input layer. The AI integration unit calculates a contextual dependency relationship between remarks by using a self-attention mechanism. The AI integration unit calculates a cosine similarity between a pre-learned agenda progression model and a current remark vector. The AI integration unit determines that a digression of a discussion has occurred when the similarity falls below 0.7 which is a preset threshold value. The AI integration unit counts an appearance frequency of an interrogative word or a specific keyword group indicating an issue in order to detect an unresolved issue. The AI integration unit inputs an input vector composed of these feature amounts into a multilayer perceptron. The AI integration unit outputs a probability score in a range of 0 to 1 from an output layer. The AI integration unit generates a flag indicating that an unresolved issue exists when the probability score exceeds 0.8. The AI integration unit generates a warning message character string by using this flag as a trigger. The AI integration unit transmits the generated character string to each terminal via a communication interface. The AI integration unit inputs a text vector of all remarks into a summarization module at the end of the meeting. The summarization module has an encoder and decoder structure. The summarization module extracts an important sentence from the input text vector. The summarization module reconstructs the extracted important sentence, and outputs summary data in a structured data format. The summary data includes each item of a main agenda, a decided matter, a next action, and an unresolved issue. The system stores this summary data in a database. The system transmits the stored summary data to a display control unit of each terminal. The display control unit renders the received summary data on a screen. With this configuration, the system realizes objective trajectory correction of a discussion that does not depend on human subjectivity. The system dramatically improves progression efficiency of a meeting. The system significantly reduces calculation resources and human resources required for creating minutes. The system brings about a technical effect of speeding up decision making in various use cases such as a software development project and a management strategy meeting. The system continuously improves accuracy of digression detection by supervised learning using past meeting data. The system optimizes a weight parameter of a model by using a backpropagation method. The system executes learning so as to minimize a cross-entropy error function.
Step 6: Confirmation of a proposal and a summary by a user and reflection on a project. In a user interface unit of the terminal, the user confirms an improvement proposal, an action plan, a meeting summary, an unresolved issue list, and the like generated by the AI, and performs approval, rejection, correction, and supplement as necessary. The approved proposal and action plan are automatically reflected in the task management unit of the server and resource allocation. For example, when “increase the number of persons in charge of a design task” proposed by the AI is approved, a person in charge list is automatically updated, and resource allocation is also recalculated. A final version of the meeting summary and the minutes is also confirmed through correction by the user, and is stored as a record of the project. Specifically, the user interface unit of the terminal arranges the received structured data as a graphical component on a screen. The user interface unit detects an input operation from the user via an event listener. When an approval operation is detected, the user interface unit generates an update request packet including an identifier of the corresponding proposal. The terminal transmits this update request packet to the server by using a secure communication protocol. The task management unit of the server analyzes the received update request packet. The task management unit specifies a corresponding record in a relational database. The task management unit starts transaction processing, and updates a field of the person in charge list. The server activates a resource allocation optimization module. The resource allocation optimization module executes a linear programming algorithm. The resource allocation optimization module sets an operable time of each person in charge, a skill level, and required man-hours of a task as constraint conditions. The resource allocation optimization module defines an objective function that minimizes a completion time of the entire project. The resource allocation optimization module searches for an optimal solution by using a simplex method. The resource allocation optimization module outputs the calculated optimal resource allocation ratio. The task management unit updates related tables of the database in a chained manner based on this output result. The task management unit commits a transaction, and guarantees data consistency. When receiving a correction operation of the meeting summary, the system extracts difference data. The system feeds back the extracted difference data to a natural language processing model. The natural language processing model uses this feedback data as a reward signal of reinforcement learning. The natural language processing model fine-tunes a parameter of summary generation by using a policy gradient method. With this configuration, the system realizes dynamic project management accurately reflecting an intention of the user. The system completely eliminates a calculation load on an administrator by automating recalculation of resources. The system exhibits a technical effect of shortening a construction period by optimal arrangement of resources in a large-scale construction project or system development. The system prevents data conflict due to simultaneous updates from a plurality of users by an exclusive control mechanism of the database.

### Specific Use Case

For example, a case is assumed where a series of processes of requirement definition, design, implementation, test, and release are progressed while being shared by a plurality of persons in charge in a system development project. At the start of the project, a project manager registers a task name, a person in charge, a start date, a deadline, a progress status, a dependency relationship, a priority, a required resource, a progress rate, a related document, a comment, and the like in detail for each process by using the user interface unit of the terminal. For example, information such as “person in charge: A”, “deadline: July 10, 2024”, “dependent task: requirement definition”, “priority: high”, “progress rate: 40%”, “related document: design document URL”, and “comment: creating design material” is input to a design task. The task management unit stores these pieces of information in a database, and monitors changes in the progress status and the dependency relationship in real time. Specifically, the task management unit converts the input task information into a structured data object. The task management unit inserts this data object into a predetermined table group of a relational database. The database includes a task table, a person in charge table, and a dependency relationship table. The task management unit constructs a dependency relationship between tasks on a memory as a data structure of a directed acyclic graph. The task management unit expresses each task as a node and a dependency relationship as an edge. The task management unit executes a topological sort algorithm, and verifies validity of an execution order of tasks. When a circular reference is detected, the task management unit generates an error code and returns the error code to the terminal. When a normal graph structure is confirmed, the task management unit gives a weight for critical path calculation to each node. The task management unit sets a required time of each task as a weight. The task management unit calculates the shortest completion period of the project by using a longest path search algorithm. The task management unit executes a daemon process for monitoring an update event of a progress status in the background. The daemon process periodically polls an update log of the database. When detecting a change in a progress rate, the daemon process updates a state of a corresponding node of the directed acyclic graph. The daemon process recalculates a degree of influence on a subsequent task. With this configuration, the system strictly manages a dependency relationship of a complexly intertwined task group as a mathematical model. The system quantitatively evaluates a delay risk of the entire project which is difficult to grasp by human intuition. The system brings about a technical effect of ensuring transparency of a schedule in various development methods such as agile development and waterfall development. The system enables recalculation in units of milliseconds even for a large-scale project having thousands of tasks by in-memory processing of a graph structure. The system reduces a CPU load of the server by improving calculation efficiency.

During progression of the project, each person in charge updates a progress status of his/her own task from the terminal at any time, and performs an operation such as changing a progress rate of an “implementation” task from 60% to 80%, adding a person in charge of a test task, and adjusting a deadline of a release task, for example. The task management unit immediately reflects these changes, and automatically recalculates a dependency relationship and resource allocation. Furthermore, communication data such as a meeting, a chat, an email, and an SNS is automatically acquired from the terminal and an external service, and is accumulated in the communication analysis unit. For example, voice data of a web meeting is transmitted to the server in real time, and is converted into text by a voice recognition engine. A message log is automatically collected from a chat tool by API linkage, and group posts and comments on an SNS are also targeted. Speaker separation and remark frequency analysis are also performed from the voice data of the meeting. Specifically, the task management unit receives a state change request from the terminal at an API endpoint in a REST format. The task management unit analyzes the received request payload, and extracts a task identifier to be updated and a change value. The task management unit updates a parameter of a corresponding node on a directed acyclic graph. The task management unit recursively executes recalculation processing for all subsequent nodes to which the change propagates. The communication analysis unit activates a plurality of data collection worker processes for linking with an external service. The data collection worker process asynchronously receives an event notification from an external system by using a webhook mechanism. The communication analysis unit divides the received voice data into frames of a certain time. The communication analysis unit applies a fast Fourier transform to each frame, and extracts a mel-frequency cepstral coefficient as a feature amount. The communication analysis unit inputs this feature amount vector into an acoustic model. The acoustic model has a hybrid architecture combining a hidden Markov model and a deep neural network. The acoustic model outputs a posterior probability of a phoneme from the input vector. The communication analysis unit converts a phoneme sequence into a word sequence by using a language model, and generates text data. The communication analysis unit inputs the extracted feature amount vector into a clustering algorithm in order to execute speaker separation processing. The clustering algorithm models a distribution of voice features by using a Gaussian mixture model. The clustering algorithm estimates a parameter by using an expectation maximization method, and classifies each utterance into a different speaker cluster. The communication analysis unit aggregates a remark time and the number of remarks of each speaker, and outputs them as numerical data. With this configuration, the system converts unstructured data generated from various channels into structured data in real time. The system completely eliminates time and effort for manual data input. The system provides a technical effect of visualizing team communication in a remote work environment. The system minimizes a processing delay in simultaneous analysis of a plurality of meetings by parallelization of voice processing.

The AI integration unit inputs all information collected from the task management unit and the communication analysis unit into the generative AI, and comprehensively analyzes the information. For example, the generative AI specifies complex factors such as a case where a delay of a design task hinders a start of an implementation task, a case where a person in charge B concurrently holds a plurality of tasks and resources are tight, and a case where it is found in a meeting that a specification of a test task is undetermined. The generative AI automatically generates a specific improvement proposal and an action plan such as “increase the number of persons in charge of a design task”, “set a specification confirmation meeting of a test task early”, and “reallocate resources of a person in charge B and add a person in charge of an implementation task”, for example, while referring to a solution example of a past similar project and an external best practice. Furthermore, automatic resetting of a priority and a deadline of a task, automatic assignment of a person in charge, automatic alert issuance at the time of a progress delay, automatic escalation at the time of risk occurrence, and the like can also be executed. Specifically, the AI integration unit combines quantitative data of a task and qualitative data of communication, and constructs a multimodal input tensor. The AI integration unit encodes a progress rate of a task, a weight of a dependency relationship, and a load score of a person in charge as a numerical vector. The AI integration unit converts a meeting text and a chat log into a high-dimensional embedding vector by a natural language processing model. The AI integration unit combines these vectors, and inputs them into a graph neural network. The graph neural network learns a dependency relationship between tasks as a graph structure. The graph neural network propagates information between adjacent nodes by using a message passing algorithm. The graph neural network updates a hidden state vector of each node. The AI integration unit inputs the updated hidden state vector into a fully connected layer, and outputs a delay probability score of each task. The AI integration unit specifies a task having a delay probability score exceeding 0.75 as a bottleneck. The AI integration unit inputs the specified bottleneck information into a reinforcement learning agent. The reinforcement learning agent includes an environment model based on a Markov decision process. The reinforcement learning agent selects an optimal action from an action space such as addition of a person in charge, extension of a deadline, and division of a task. The reinforcement learning agent optimizes a policy based on a reward function that minimizes a completion delay of a project. The reinforcement learning agent updates an action value function by using a Q-learning algorithm. The reinforcement learning agent outputs a combination of actions having the highest value as an improvement proposal. The AI integration unit inputs this output into a natural language generation module, and generates an action plan in a text format understandable by a human. With this configuration, the system executes advanced predictive inference beyond simple data aggregation. The system prevents a crisis of a project involving complex factors. The system brings about a technical effect of strongly supporting decision making of a project manager in a large-scale system integration project. The system extracts a hidden pattern of a complex dependency relationship with high accuracy by adopting a graph neural network.

Even during progression of a meeting and a chat, the AI integration unit utilizes the generative AI in real time, and when detecting a digression of a discussion or existence of an unresolved issue, automatically notifies the terminal of advice and a reminder such as “please confirm the unresolved issue before transition to a next agenda”, “there is a similar case in the past for this discussion, and there is an example solved by adjustment between persons in charge”, and “a progress report of a test task is missing”. After the meeting ends, minutes, a summary, a decided matter, a next action, an unresolved issue list, and the like automatically generated by the AI are distributed to the terminal, and a participant can confirm contents and add a correction or a supplement as necessary. The unresolved issue and the next action extracted by the AI are automatically registered in the task management unit, and are centrally managed as a project task. Specifically, the AI integration unit implements a streaming data processing engine. The streaming data processing engine divides continuously flowing text data at regular intervals by micro-batch processing. The AI integration unit temporarily stores the divided text chunks in an in-memory database. The AI integration unit inputs the text chunk into a context analysis model. The context analysis model includes a bidirectional long short-term memory network. The context analysis model learns a bidirectional dependency relationship between a past context and a current remark. The context analysis model outputs a relevance score indicating whether each remark is related to a current agenda. The AI integration unit sets a digression flag of a discussion when the relevance score continuously falls below a threshold value. The AI integration unit executes a vector similarity search on a past project database. The AI integration unit calculates an inner product of an embedding vector of current discussion contents and a vector of a past solution example. The AI integration unit extracts top three examples having the highest inner product values. The AI integration unit generates a reminder message by using metadata of the extracted examples. The AI integration unit push-notifies the generated message to each terminal via a publish-subscribe type messaging system. When detecting a meeting end event, the AI integration unit activates an extraction module. The extraction module specifies a task name, a person in charge name, and a date expression of a deadline from text by using a named entity extraction algorithm. The extraction module formats the specified information as a structured task object. The AI integration unit transmits this task object to an API of the task management unit. The task management unit inserts the received task object into a database as a new record. With this configuration, the system seamlessly converts a remark during a meeting into an immediately executable task. The system physically prevents omission of task registration. The system exhibits a technical effect of ensuring reliable execution of an action item in a scrum meeting of agile development or the like. The system suppresses latency in real-time processing to the order of milliseconds by a combination of in-memory processing and asynchronous communication.

A user can confirm a progress status of an entire project, a state of each task, an alert of a bottleneck and a risk, an improvement proposal by AI, a summary of a meeting, an unresolved issue list, and the like at a glance on a dashboard screen of the terminal. The progress status of the task is displayed in a Gantt chart or Kanban board format, and a state change of the task and assignment of a person in charge are possible by drag and drop. Regarding the improvement proposal generated by the AI, the user can approve or reject it with one click, and the approved proposal is automatically reflected in the task management unit and resource allocation. Specifically, a display control unit of the terminal analyzes structured data received from the server, and passes the structured data to a front-end rendering engine. The rendering engine constructs a virtual document object model. The rendering engine applies only a changed part of data to an actual document object model, and optimizes redrawing of a screen. The display control unit calculates a length and a position of a bar of the Gantt chart in units of pixels by using timestamp data of a start date and an end date of the task. The display control unit defines each column of the Kanban board as a state matrix on a memory. The display control unit detects a drag and drop operation by the user as a coordinate event of a pointing device. The display control unit specifies a target column from coordinates where a drop event has occurred. The display control unit updates a state attribute of the task to a value of a new column. The display control unit transmits this state change to the server in the background by using an asynchronous communication object. The display control unit renders the improvement proposal by the AI as a modal window or a dedicated notification panel on the forefront of the screen. The display control unit binds a unique event handler to each of an approval button and a rejection button. When detecting a click event of the approval button, the display control unit generates a payload including an identifier of the proposal and an approval flag. The terminal transmits this payload to the task management unit of the server. The task management unit of the server executes a transaction of a database based on the received payload, and simultaneously updates a related task record and a resource allocation table. With this configuration, the system provides an intuitive and high-speed user interface. The system significantly reduces a cognitive load on the user. The system brings about a technical effect of reducing an operation error and improving work efficiency in complex project management work. The system prevents freezing of the screen and maintains smooth operability even when a large amount of task data exists by adopting the virtual document object model. The system completely synchronizes state management on a client side and data persistence on a server side.

Specific examples of a prompt sentence to be read by the generative AI include “Please analyze the following task information and communication log, identify a bottleneck of a progress delay and resource tightness, and generate a specific improvement proposal. Task information: design task, person in charge A, deadline July 10, progress 40%, dependent task: requirement definition. Communication log: person in charge A complains about a lack of resources in a meeting.”, “Please summarize the following meeting voice text, and extract a main agenda, a decided matter, an unresolved issue, and a next action. Meeting text: in today's meeting, it was discussed that progress of a test task was delayed, and it was decided to raise a priority of a release task.”, and “Please extract a remark regarding a risk and an issue from the following chat log, and link the remark to a related task. Chat log: Mr. B requests a specification change of an implementation task. Mr. C reports a progress delay of a test task.” Furthermore, an advanced prompt such as “Please compare a past project history and current task progress, predict a risk that may occur in the future, and present a countermeasure plan.” can also be utilized. Specifically, the AI integration unit includes a prompt generation module. The prompt generation module executes a process of combining structured data and unstructured text extracted from a database and embedding them into a predetermined template. The prompt generation module counts the number of tokens of input data. The prompt generation module applies a text truncation or summarization process as preprocessing so as not to exceed a limit of a context window of a large language model. The prompt generation module converts the text into an array of subword tokens by using a byte pair encoding algorithm. The AI integration unit supplies this token array to an input layer of the large language model. The large language model is composed of a transformer network having billions of parameters. The large language model analyzes a context of the input prompt by a self-attention mechanism. The large language model calculates an appearance probability distribution of a next token. The large language model generates a token sequence with the highest probability by using a beam search algorithm. The AI integration unit decodes the generated token sequence and outputs it as natural language text data. The AI integration unit applies post-processing using a regular expression to the output text data. The AI integration unit extracts structured data in a JSON format from the text. The AI integration unit utilizes the extracted structured data as an input for a subsequent task update process and screen display process. With this configuration, the system dynamically generates a natural instruction sentence as described by a human, and maximizes inference capability of an AI model. The system stabilizes quality of an output result by automation of prompt engineering. The system exhibits a technical effect of flexibly adapting to various project situations and realizing highly accurate prediction of a risk and presentation of a solution. The system incorporates a few-shot learning method and further improves output accuracy of the model by including several past success examples in the prompt.

In this way, in a project involving a plurality of tasks and persons in charge, the system of the present invention centrally manages task information and communication data, realizes automatic extraction of a bottleneck and a risk, automatic generation of a specific improvement proposal, summarization of meeting contents, real-time discussion support, and the like by using a generative AI, and can aim at efficiency improvement and optimization of project management and team collaboration. Specifically, the system adopts a distributed computing architecture. The system containerizes a task management unit, a communication analysis unit, and an AI integration unit as independent microservices, respectively. The system deploys these services on a parallel computing cluster by using a container orchestration tool. The system optimally distributes a request from a terminal to each container via a load balancer. The system uses a lightweight remote procedure call protocol for communication between the respective services. The system constructs a polyglot persistence architecture combining a relational database and a document-oriented database for data persistence. The system stores structured task information in the relational database, and stores an unstructured communication log in the document-oriented database. The system allocates a dedicated computing node equipped with a GPU in order to speed up an inference process of the generative AI. The system applies a quantization technology of an inference model, and converts precision of a parameter from a 32-bit floating point to an 8-bit integer. Thereby, the system suppresses consumption of a memory bandwidth and improves an inference speed. With this configuration, the system maintains high scalability and availability even in a large-scale project environment accessed by thousands of users simultaneously. The system eliminates a single point of failure and enhances fault tolerance of the entire system. The system brings about a technical effect of providing real-time decision-making support without delay by parallelization of data processing and speeding up of inference. The system breaks through a limit of conventional manual information collection and analysis, and dramatically improves processing efficiency of computer technology itself. The system improves a success probability of a project at a statistically significant level.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments of the present invention will be described more specifically and in detail. The system of the present invention centrally manages progress of a plurality of robots and production tasks in a factory, a dependency relationship, an operating status of a robot, a maintenance history, a state of a consumable part, a communication log with a field worker, and the like, and generates and presents optimization of an entire production line, automatic extraction of a bottleneck and a risk, optimal robot allocation and a maintenance plan, and an improvement plan for a work procedure in real time by using a generative AI. Specifically, the system functions as a cyber-physical system. The system is connected to a controller of each robot arranged in a physical space in the factory via a network. The system arranges an edge computing device in each production line. The edge computing device samples high-frequency sensor data output from the robot in milliseconds. The edge computing device applies a low-pass filter process to the acquired raw data to remove high-frequency noise. The edge computing device transmits the data after noise removal to a central server by using a lightweight messaging protocol. The central server stores the received data in a time-series database. The central server cooperates with a task management database and a communication log database. The central server extracts data from these heterogeneous database groups and constructs an integrated data warehouse. The central server operates a generative AI model on this integrated data warehouse. The generative AI model has an architecture that accepts multimodal input data. The generative AI model simultaneously processes time-series sensor data, structured task data, and natural language text data. The generative AI model includes a dedicated encoder group that extracts a feature amount of each modality. The generative AI model integrates the extracted feature amount vectors in a coupling layer and maps them to a shared representation space. With this configuration, the system mathematically associates information of completely different dimensions, which are an operating state of a physical machine and human communication. The system constructs a digital twin of the entire factory in a virtual space. The system exhibits a technical effect of maximizing production efficiency and minimizing downtime in a complex manufacturing industry such as automobile manufacturing and electronic component assembly. The system completely automates a loop from data collection to inference and feedback, and minimizes human intervention.

First, a robot management unit records and manages detailed information such as a robot ID, an operating state (normal, abnormal, stopped, under maintenance, etc.), a workload (percentage or absolute value), a last maintenance date, an abnormality occurrence history, an operating time, an assigned task, a maintenance history, and a state of a consumable part (for example, a wear degree of an arm, a deterioration degree of a sensor, a remaining battery level, a replacement timing of grease, a motor temperature, a history of an error code, etc.) for all robots operating in a factory. For example, information such as robot A is operating normally with a workload of 80%, a last maintenance date is June 1, 2024, an arm wear degree is 70%, a remaining battery level is 60%, an assigned task is “assembly”, there is a history of two abnormal stops in the past, a motor temperature is on an upward trend, grease replacement is necessary, and sensor calibration is unexecuted is held. Furthermore, the robot management unit also records an accumulated operating time for each robot, an abnormality occurrence frequency, and a maintenance history (for example, “arm replacement on May 10, 2024”, “battery replacement on June 1, 2024”, “sensor calibration on June 15, 2024”, etc.) in chronological order. For example, a detailed history such as robot B had five abnormal stops in the past year, three of which were motor abnormalities in the same part, is also managed. Specifically, the robot management unit continuously receives telemetry data from an IoT sensor group mounted on each robot. The robot management unit parses the received telemetry data and extracts a numerical value of each parameter. The robot management unit expands the extracted numerical values on a memory as a multidimensional time-series array. The robot management unit extracts a trend component by using a moving average method for continuous value data such as a motor temperature and a vibration frequency. The robot management unit inputs the extracted trend component to an abnormality detection model. The abnormality detection model adopts an autoencoder architecture. The abnormality detection model is pre-trained by using sensor data at a normal time. The abnormality detection model compresses input data into a low-dimensional latent space and restores it to an original dimension again. The robot management unit calculates a reconstruction error between the input data and the restored data. When the reconstruction error exceeds a dynamically set threshold, the robot management unit increases a deterioration degree score of a corresponding part. The robot management unit converts a history of an error code as an embedding vector of natural language processing, and calculates a similarity with a past failure pattern. The robot management unit writes these calculation results into a robot status table of a relational database by using an UPDATE statement. With this configuration, the system mathematically captures a minute change in an internal part that cannot be confirmed visually. The system triggers preventive maintenance before a sudden failure occurs. The system brings about a technical effect of maximizing an operating rate of expensive equipment such as a semiconductor manufacturing apparatus. The system processes a search query for a huge maintenance history of several years in milliseconds by compression and indexing of time-series data.

A task management unit records and manages detailed information such as a task name, an assigned robot, a deadline, a progress status (unstarted, in progress, completed, delayed, etc.), a dependency relationship (pre-process/post-process), a priority, a required resource, a progress rate, a related document (work instruction, design drawing, quality standard document, work video, etc.), a necessity of maintenance, a past history, a comment, and tagging information for all production tasks executed in a factory. For example, a “welding” task is assigned to robot B, a deadline is July 10, 2024, a progress rate is 60%, a dependent task is an “assembly” task, a priority is high, and a “welding procedure manual”, a “quality inspection standard document”, a “past defective product analysis report”, and the like are linked as related documents. The task management unit receives addition/editing/deletion of a task, allocation change of an assigned robot, adjustment of a deadline, update of a progress rate, setting/change of a dependency relationship, and the like in real time, and also manages a complex dependency relationship between tasks in a graph structure. For example, an “inspection” task is started after waiting for completion of the “welding” task, but when the “welding” task is delayed, a start timing of the “inspection” task and allocation of an assigned robot can be automatically reviewed. Furthermore, an inventory status of jigs, tools, and parts required for each task, allocation of a work place, pass/fail judgment of a quality inspection, and a work environment (temperature, humidity, illuminance, etc.) are also recorded, and a tendency such as “welding quality is likely to deteriorate under a high-temperature environment” can also be managed. Specifically, the task management unit includes a production scheduling engine. The production scheduling engine constructs a dependency relationship of tasks on a memory as a directed acyclic graph. The production scheduling engine assigns attribute data of a task to each node as a property. The production scheduling engine executes a solver of a constraint satisfaction problem. The solver defines an operable time of a robot, an inventory quantity of parts, and an allowable range of a work environment as hard constraints. The solver defines minimization of an overall production lead time as a soft constraint. The solver searches for an executable schedule solution by using a backtracking algorithm. When detecting a delay event of a preceding task, the task management unit restarts the solver via an event-driven architecture. The solver re-evaluates the graph starting from a delayed node. The solver shifts a start time of a subsequent task and searches for a free time of an alternative robot. The task management unit calculates Pearson's product-moment correlation coefficient in order to analyze a correlation between work environment data and a quality inspection result. When a strong positive correlation is recognized between temperature data and a defective product occurrence rate, the task management unit adds the condition to a rule-based engine as a new constraint rule. With this configuration, the system autonomously maintains an optimal production plan at all times in a dynamically changing factory environment. The system completely substitutes for a rescheduling work manually performed by a human planner. The system exhibits a technical effect of minimizing a setup change time in a site of high-mix low-volume production. The system completes recalculation of a complex process chart reaching tens of thousands of nodes in real time by optimizing a scanning algorithm of a graph structure.

A communication log management unit automatically acquires various communication data such as a meeting, a chat, a voice call, an email, and an SNS occurring with a field worker, and accumulates them in chronological order. For example, when a field worker transmits a report or a request such as “operation of robot C is unstable”, “there is an unclear point in a work procedure of task D”, “request battery replacement of robot E”, “a work place of task F is crowded”, “detect a sensor abnormality of robot G”, and “defective products frequently occur in a quality inspection of task H” from a tablet terminal, these pieces of information are recorded as a communication log. Furthermore, meeting voice data is converted into text by a voice recognition engine, and remark contents and frequency for each speaker are also analyzed. From contents of a chat and an email, an abnormality report, a work instruction, a maintenance request, a progress report, raising of an issue, an intention indication of approval or rejection, a remark regarding a risk, an improvement request for a work procedure, progress of troubleshooting at a site, know-how sharing between workers, an improvement proposal for a work environment, and the like are extracted. For example, feedback from a site such as “an arm replacement procedure of robot I is difficult to understand”, “want a work video of task J to be distributed to a site”, and “caution because a grease replacement timing of robot K is near” is also recorded in detail. Specifically, the communication log management unit constructs a data ingest pipeline corresponding to a plurality of communication protocols. The communication log management unit receives an HTTP request from a tablet terminal and extracts text data in a payload. The communication log management unit receives voice stream data via WebSocket. The communication log management unit inputs the received voice data to a voice recognition model based on a deep neural network, and converts it into a text character string. The communication log management unit inputs all the acquired text data to a natural language processing pipeline. The natural language processing pipeline divides text into words by using a morphological analyzer. The natural language processing pipeline applies a named entity extraction model. The named entity extraction model tags a specific entity such as a robot ID, a task name, and a part name from text by using a conditional random field algorithm. The natural language processing pipeline applies an intent classification model. The intent classification model classifies an intent of text into a predefined class such as “abnormality report”, “maintenance request”, and “improvement proposal” by using a support vector machine. The communication log management unit formats the extracted entity, the classified intent, and original text data as a structured JSON document. The communication log management unit indexes and stores this JSON document in a document-oriented database equipped with a full-text search engine. With this configuration, the system converts tacit knowledge and qualitative sensory information at a site into quantitative data processable by a computer. The system directly utilizes a voice of a field worker as an input parameter for system control. The system brings about a technical effect of preventing an omission of collection of near-miss information at a manufacturing site and strengthening safety management. The system speeds up a search for a past similar trouble by an inverted index structure of a full-text search engine.

An AI integration unit inputs all information collected from a robot management unit, a task management unit, and a communication log management unit to a generative AI, and analyzes it comprehensively and in a multivariate manner. The generative AI comprehensively analyzes, for example, a progress status and a dependency relationship of a task, an operating state and a workload of a robot, a necessity of maintenance, an abnormality occurrence status, a maintenance history, a state of a consumable part, an abnormality report and a request from a field worker, work environment data, a quality inspection result, a past trouble history, and the like, and automatically extracts a bottleneck and a risk of an entire production line. For example, when a “welding” task is unstarted due to a delay of an “assembly” task, progress acceleration of the “assembly” task and an increase in assigned robots are proposed. When robot B is in an abnormal state and has a workload of 95%, inspection, temporary suspension, and task reallocation to another robot are recommended. When an “inspection” task requires maintenance, execution of maintenance of an assigned robot and schedule adjustment are recommended. When a deterioration degree of a consumable part exceeds a threshold, part replacement and preventive maintenance are proposed. For example, a specific action such as “recommend arm replacement because an arm wear degree of robot C exceeds 90%”, “recommend temporary task allocation to robot E because progress of task D is delayed”, “automatically notify an instruction of reconfirmation of a work procedure to a field worker”, and “reconfirm temperature and humidity of a work environment and change a work condition as necessary because defective products frequently occur in a quality inspection of task F” is automatically generated. Specifically, the AI integration unit executes feature engineering for integrating information from heterogeneous data sources. The AI integration unit normalizes a deterioration degree score calculated from sensor data of a robot, a delay time of a task, and a negative emotion score extracted from a communication log. The AI integration unit combines these normalized numerical values and generates a high-dimensional feature amount vector. The AI integration unit inputs this feature amount vector to a gradient boosting decision tree model. The gradient boosting decision tree model has an ensemble learning architecture in which a plurality of weak learners are connected in series. The gradient boosting decision tree model performs regression calculation of an occurrence probability of each risk factor from an input vector. The AI integration unit identifies a risk factor whose calculated probability exceeds a predetermined threshold. The AI integration unit embeds the identified risk factor and a current system state into a prompt template. The AI integration unit inputs the constructed prompt to a large language model. The large language model autoregressively generates a text sequence of an optimal solution to a risk by using a decoder block of a transformer. The large language model is fine-tuned to include a specific control command such as task reallocation and parameter change in an output in a JSON format in a generation process. The AI integration unit parses the output JSON data and generates a control API call to each management unit. With this configuration, the system processes physical sensor data and human language data in the same inference space. The system detects a sign of a complex failure that cannot be found by a single data source. The system exhibits a technical effect of autonomous line control and minimization of downtime in a smart factory. The system presents a judgment basis of an AI in a human-interpretable form by analyzing a branch condition of a decision tree.

Furthermore, the generative AI can make a more advanced improvement proposal by utilizing knowledge such as “when a similar abnormal stop occurred in the past, it was solved by arm replacement and an update of control software”, “when a plurality of tasks were delayed, a delivery time was shortened by task division and addition of an assigned robot”, and “when defective products frequently occurred in a quality inspection, it was improved by a review of a work procedure and worker education” while referring to a solution example of a past similar project and an external best practice. In addition, the AI integration unit can also execute automatic resetting of a priority and a deadline of a task, automatic allocation of an assigned robot, automatic alert issuance at the time of a progress delay, automatic escalation at the time of risk occurrence, automatic generation of a maintenance plan, real-time notification to a field worker, automatic distribution of a work procedure, automatic feedback at the time of a quality abnormality, and the like. Specifically, the AI integration unit implements a retrieval-augmented generation architecture. The AI integration unit inputs a past solution example and a manual document to a sentence embedding model in advance. The sentence embedding model converts text into a 768-dimensional dense vector. The AI integration unit stores the generated dense vector in a vector database and constructs an index for an approximate nearest neighbor search. The AI integration unit inputs a text description of a currently occurring abnormal state as a query to the sentence embedding model, and generates a query vector. The AI integration unit calculates a cosine similarity between the query vector and a stored vector for the vector database. The AI integration unit extracts top five past example documents with the highest similarity. The AI integration unit combines text of the extracted documents as a context into a prompt. The AI integration unit inputs the augmented prompt to a large language model. The large language model generates a specific improvement proposal text optimized for a current situation based on the provided context. The AI integration unit extracts an executable action item from the generated proposal text. The AI integration unit calls an API of a task management unit and updates a deadline parameter of a task. The AI integration unit calls an API of a robot management unit and newly creates a record of a maintenance schedule. The AI integration unit push-distributes an alert notification to a wearable terminal of a field worker via a messaging broker. With this configuration, the system instantly applies a huge amount of past experiential knowledge to current problem solving. The system systematizes know-how of a skilled worker and eliminates personalization. The system brings about a technical effect of dramatically shortening a troubleshooting time at a manufacturing site. The system suppresses hallucination and guarantees an accurate proposal based on facts by a combination of a vector search and a generative model.

For example, when a report that “operation of robot D is unstable” is recorded in a communication log at a site, an AI integration unit collates it with an abnormality occurrence history and a maintenance history of a robot management unit, a progress status of an assigned task of a task management unit, and work environment data, and instantly proposes cause analysis of an abnormality, necessary maintenance work, reallocation of an assigned task, a review of a work procedure, and the like. For example, a specific action such as “recommend arm replacement because an arm wear degree of robot D exceeds 90%”, “recommend temporary task allocation to robot E because progress of task D is delayed”, “automatically notify an instruction of reconfirmation of a work procedure to a field worker”, and “recommend a review of an air conditioning setting because a temperature of a work environment exceeds a reference value” is automatically generated. Specifically, when receiving a new abnormality report text from a communication log management unit, the AI integration unit asynchronously activates an inference pipeline. The inference pipeline extracts “robot D”, which is an identifier of a target robot, from the text by using a regular expression. The AI integration unit issues an SQL query to a database of the robot management unit by using this identifier as a key. The AI integration unit acquires numerical data of a current arm wear degree of robot D, the number of abnormality occurrences in the past one month, and a timestamp of a last maintenance date and time. The AI integration unit simultaneously issues a query to a database of the task management unit, and acquires a progress rate and a dependency relationship graph of a task currently being executed by robot D. The AI integration unit calculates an average value of temperature data for the latest one hour from a time-series database of an environmental sensor. The AI integration unit summarizes these collected data into a structured context object. The AI integration unit executes hybrid inference of a rule-based inference engine and a machine learning model. The inference engine determines whether or not the arm wear degree exceeds 85%, which is a threshold, by a logical operation. When a condition is true, the inference engine generates an action code of “recommend arm replacement”. The AI integration unit compares current workload scores of all other robots in order to determine task reallocation. The AI integration unit selects robot E, which has the lowest load score and is equipped with a necessary tool, as an alternative resource. The AI integration unit inputs these inference results to a natural language generation model, and generates a proposal text in a human-readable format. With this configuration, the system automatically executes strict logical inference across a plurality of databases triggered by an ambiguous natural language report. The system completely saves time and effort for an administrator to manually check each system. The system exhibits a technical effect of shortening a lead time from occurrence of an abnormality to determination of a countermeasure to a level of several seconds. The system achieves both reliable compliance with a safety standard and flexible resource optimization by a combination of a rule base and machine learning.

In addition, for example, when a plurality of robots are simultaneously in a high-load state and overall production efficiency is lowered, an AI integration unit proposes task reallocation for equalizing a workload for each robot, new task allocation to a low-load robot, optimization of a maintenance schedule, and the like. For example, a proposal such as “allocate a new task to robot C because robots A and B are operating with a load of 90% or more”, “execute maintenance of robot B ahead of schedule and minimize downtime”, and “allocate task F to robot G in order to distribute a workload of robot D” is made. Specifically, the AI integration unit makes a load monitoring daemon process resident. The load monitoring daemon process samples a CPU usage rate, a torque value of a motor, and a length of a task queue of all robots at a constant cycle. The AI integration unit normalizes these indices and calculates a comprehensive load score of each robot. The AI integration unit calculates a variance value of the comprehensive load score and quantifies a load bias of an entire factory. When the variance value exceeds a preset allowable threshold, the AI integration unit activates a dynamic load balancing algorithm. The dynamic load balancing algorithm constructs a queuing model based on queuing theory. The dynamic load balancing algorithm models each robot as a server node and a task as a job. The dynamic load balancing algorithm pops an unstarted task from a task queue of a high-load node. The dynamic load balancing algorithm executes a simulation of pushing the task to a task queue of a low-load node. The dynamic load balancing algorithm compares a movement cost of a task and a shortening effect of a processing time by using an evaluation function. The dynamic load balancing algorithm discovers an optimal combination of task arrangement by using a heuristic search. The AI integration unit updates an assigned robot ID field of a database of a task management unit based on the optimized task arrangement. The AI integration unit turns on a maintenance flag of robot B whose accumulated value of an operating time is close to a specified value in order to reduce a failure risk due to a high load. The AI integration unit transmits an insertion request of a maintenance frame to a production scheduler. With this configuration, the system autonomously resolves occurrence of a bottleneck due to a local overload. The system maximizes throughput of the entire factory. The system brings about a technical effect of extending a life of a robot and improving cost-effectiveness of capital investment. The system minimizes an overhead accompanying movement of a task by optimization based on a simulation.

Furthermore, for example, when there is a report from a field worker that “there is an unclear point in a work procedure of an E task”, the AI integration unit automatically searches a related document, a past work history, a procedure manual of a similar task, and the like, and presents an optimal work procedure and an FAQ to the field worker. For example, support such as “referring to a standard work procedure manual of the E task”, “presenting a response history when there was a similar inquiry in the past”, “distributing a work video to a field terminal”, and “automatically notifying a point of the work procedure by a chat” is possible. Specifically, the AI integration unit executes an intention extraction process on text data received from a communication log management unit. When a keyword such as “unclear”, “do not know”, or “tell me” is included in the text, the AI integration unit fires an information search request event. The AI integration unit extracts the “E task” which is an identifier of a target task from the text. The AI integration unit constructs a search query for a document management database. The document management database holds metadata of various manuals and video files in a vector format. The AI integration unit executes a hybrid search by a TF-IDF algorithm and a BERT model using the extracted task identifier and a context vector of question contents. The AI integration unit calculates a total relevance score by weighting and adding an exact match score of the keyword and a semantic similarity score. The AI integration unit acquires a URI of a top document having the highest total relevance score. The AI integration unit extracts a past Q&A pair regarding the same task from a past response history database. The AI integration unit generates a response payload including the acquired URI of the document, the Q&A text, and a streaming link of the work video. The AI integration unit transmits this response payload to a tablet terminal of the field worker via an HTTPS protocol. A display control unit of the terminal renders the received data on a chat interface on a screen. With this configuration, the system immediately provides accurate information to a question of the worker. The system physically prevents rework and a mistake of work. The system exhibits a technical effect of reducing time for an administrator to go to a site and provide guidance, and improving labor productivity. By adopting the hybrid search algorithm, the system maintains high search accuracy even for orthographical variants of technical terms and ambiguous expressions.

Furthermore, for example, when rejected products frequently occur in a quality inspection, the AI integration unit comprehensively analyzes a work history of the task management unit, an operating state of the robot management unit, work environment data, an abnormality report of a communication log, and the like, identifies a cause such as “temperature and humidity of a work environment are out of reference values”, “sensor calibration of a robot is unexecuted”, and “a part of a work procedure is misunderstood at a site”, and presents an improvement measure. For example, the AI integration unit automatically generates an action such as “adjusting the temperature of the work environment within the reference value”, “executing the sensor calibration”, and “executing re-education of the work procedure”. Specifically, the AI integration unit receives occurrence rate data of the rejected products from a quality management system. When the occurrence rate exceeds a control limit line of statistical process control, the AI integration unit activates a root cause analysis module. The root cause analysis module includes a causal inference model based on a Bayesian network. The root cause analysis module collects data of a past certain period from each database based on an occurrence time of the rejected product. The root cause analysis module sets time-series data of the temperature and humidity of the work environment, a calibration history flag of the robot in charge of the corresponding task, and an emotional polarity score of the related communication log as input variables. The root cause analysis module calculates a conditional probability between these input variables and a result variable of quality deterioration. The root cause analysis module estimates a posterior probability distribution using a Markov chain Monte Carlo method. The root cause analysis module calculates a contribution score that each factor gives to the quality deterioration. The AI integration unit identifies a factor having the highest contribution score as a main cause. When the contribution of the temperature is high, the AI integration unit transmits a change command of a set temperature to an air conditioning control system via an API. When the contribution of the unexecuted calibration is high, the AI integration unit transmits a schedule registration request for maintenance execution to the robot management unit. The AI integration unit generates a log of these analysis results and the executed action as a report, and transmits the report to a terminal of an administrator. With this configuration, the system objectively identifies a true cause of a quality defect in a complex manufacturing process by data driving. The system eliminates troubleshooting relying on experience and intuition. The system brings about direct economic and technical effects of improving a yield rate and reducing a disposal cost. By probabilistic inference of the Bayesian network, the system derives a highly reliable causal relationship even from noisy field data.

As described above, in the embodiment of the present invention, the robot management unit, the task management unit, the communication log management unit, and the AI integration unit cooperate to centrally and in real time manage and analyze a robot and a production task in a factory, communication of a field worker, a work environment, and quality information, and highly automate and improve efficiency of optimization of an entire production line, automatic extraction of a bottleneck and a risk, optimal robot allocation and a maintenance plan, an improvement plan for a work procedure, an alert notification to a site, automatic feedback at the time of a quality abnormality, and the like by using a generative AI, thereby comprehensively realizing optimization of entire factory operation, productivity improvement, quality maintenance, maintenance cost reduction, and field worker support, which could not be realized by conventional manual management or a simple automation tool. Specifically, the system implements each management unit as a loosely coupled microservice architecture. The system uses an event streaming platform for data linkage between respective services. Thereby, the system processes tens of thousands of pieces of sensor data and log data per second without loss. The system distributedly arranges an inference engine of the generative AI in an edge server and a cloud server. The system processes abnormality detection and an alert notification requiring immediacy on an edge side, and suppresses a communication delay to a millisecond order. The system batch-processes a computation-intensive task such as analysis of past data and large-scale schedule optimization in a GPU cluster on a cloud side. The system maximizes utilization efficiency of computing resources by this hybrid computing environment. The system constructs a feedback loop that directly reflects a control command based on an inference result of the AI on an operation of a physical robot via a programmable logic controller. With this configuration, the system seamlessly converts an analysis result of an information space into control of a physical space. The system causes the entire factory to function as one huge autonomous robot. The system exhibits a technical effect of embodying an advanced cyber-physical system aimed at by Industry 4.0. By continuous machine learning, the system provides a self-evolving production infrastructure in which inference accuracy improves as operation data of the factory is accumulated. The system realizes a software-driven productivity revolution exceeding hardware constraints.

### System Configuration

The system according to the present embodiment includes a robot management unit, a task management unit, a communication log management unit, an AI integration unit, a user interface unit, and a data linkage unit. The robot management unit records and manages in detail a robot ID, an operating state, a workload, a last maintenance date, an abnormality occurrence history, an operating time, an assigned task, a maintenance history, a state of a consumable part, a motor temperature, a remaining battery level, a grease replacement timing, a sensor calibration history, an error code history, and the like for all robots operating in a factory. For example, when a robot A is operating normally and has a workload of 80%, a last maintenance date is June 1, 2024, an arm wear degree is 70%, a remaining battery level is 60%, an assigned task is “assembly”, there is a history of two abnormal stops in the past, a motor temperature tends to rise, grease replacement is necessary, and sensor calibration is unexecuted, all these pieces of information are managed in chronological order, and an abnormality occurrence frequency and a maintenance history are also recorded in detail. Furthermore, when a robot B has five abnormal stops in the past year, and three of them are motor abnormalities in the same part, the history is also managed and utilized for a plan of part replacement and preventive maintenance. Specifically, the system operates in a distributed computing environment. The robot management unit streaming-receives time-series sensor data from each robot. The system expands the received data on a memory as time-series tensor data. The system implements a time-series prediction model based on deep learning. The time-series prediction model includes a long short-term memory network or a self-attention mechanism. The system inputs a motor temperature, a vibration frequency, a current value, and the like of the robot to the model as a multidimensional vector. The system executes a normalization process and noise removal filtering on input data. For example, the system inputs a sensor value for the past 100 milliseconds as a 64-dimensional vector. The model calculates a hidden state representation from the input vector. The model outputs an abnormality occurrence probability score and a predicted value of a remaining life of each robot. For example, the model outputs an abnormality probability as a floating-point number of 0.85. The model outputs the remaining life as numerical data of 360 hours. The system compares the output abnormality probability score with a preset threshold value. When the score exceeds the threshold value, the system executes an alert issuing process. The system automatically updates a maintenance plan database based on the predicted remaining life. The system minimizes downtime by these processes. The system significantly reduces a maintenance cost by optimizing a replacement timing of a part. The system realizes highly accurate deterioration prediction that does not depend on a human rule of thumb. The system detects a sign of a minute abnormality at an early stage by calculation in a high-dimensional space. The system continuously learns a weight parameter of the model from past failure record data using an error backpropagation method. The system adopts a cross-entropy error or a mean squared error as a loss function. The system augments learning data by adding minute Gaussian noise to the sensor data as a data augmentation method. The system improves computer technology itself by these technical processes.

The task management unit records and manages in detail a task name, an assigned robot, a deadline, a progress status, a dependency relationship, a priority, a required resource, a progress rate, a related document, a necessity of maintenance, a past history, a comment, tagging information, a work location, a quality inspection result, work environment data, and the like for all production tasks executed in the factory. For example, a “welding” task is assigned to the robot B, a deadline is July 10, 2024, a progress rate is 60%, a dependent task is an “assembly” task, a priority is high, and a “welding procedure manual”, a “quality inspection standard document”, a “past defective product analysis report”, and the like are linked as related documents. The task management unit also performs addition/editing/deletion of a task, allocation change of an assigned robot, adjustment of a deadline, update of a progress rate, setting/change of a dependency relationship, an inventory status of a necessary jig/tool and part, allocation of a work location, pass/fail determination of a quality inspection, and recording of a work environment (temperature, humidity, illuminance, etc.). For example, an “inspection” task is started after waiting for completion of the “welding” task, but when the “welding” task is delayed, a start timing of the “inspection” task and allocation of an assigned robot can be automatically reviewed. In addition, when rejected products frequently occur in the quality inspection, work environment data and a history of a work procedure are referred to and utilized for cause analysis and an improvement proposal. Specifically, the system executes the task management unit as an independent microservice. The task management unit constructs a dependency relationship between tasks as a directed acyclic graph on a memory. The system infers optimal scheduling of a task using a graph neural network. The system defines a required time and a required resource of each task as a node feature amount. The system defines strength of a dependency relationship between tasks as an edge feature amount. The system converts these feature amounts into a matrix representation and inputs the matrix representation to the model. For example, the system inputs a graph including 100 tasks as a feature matrix of 100 rows and 64 columns. The model executes a message passing algorithm to aggregate information between adjacent nodes. The model outputs an optimal start time vector and a resource allocation probability distribution of each task. For example, the model outputs a start time of a task A as a time stamp of an absolute time. The model outputs an allocation probability of the robot B as a numerical value of 0.92. The system dynamically rearranges a task queue based on the output probability distribution. The system transmits a control command to each robot according to the optimized schedule. The system maximizes production throughput by these processes. The system avoids resource conflict in advance. The system solves a complex dependency relationship, which is difficult to handle by a conventional rule-based scheduler, at high speed. The system optimizes a scheduling policy using reinforcement learning. The system updates the model using a completion time of a task as a reward signal. The system simulates a plurality of alternative schedules in parallel and selects the best one. The system dramatically improves calculation efficiency by these technical processes.

The communication log management unit automatically acquires various communication data such as a meeting, a chat, a voice call, an email, and an SNS occurring with a field worker, and accumulates the communication data in chronological order. For example, when a field worker transmits a report or a request such as “an operation of a robot C is unstable”, “there is an unclear point in a work procedure of a D task”, “requesting battery replacement of an E robot”, “a work location of an F task is crowded”, “detecting a sensor abnormality of a G robot”, and “rejected products frequently occur in a quality inspection of an H task” from a tablet terminal, these pieces of information are recorded as a communication log. Furthermore, meeting voice data is converted into text by a voice recognition engine, and utterance contents and frequency for each speaker are also analyzed. From contents of a chat and an email, an abnormality report, a work instruction, a maintenance request, a progress report, raising of an issue, an intention indication of approval or rejection, a remark regarding a risk, an improvement request for a work procedure, progress of troubleshooting at a site, know-how sharing between workers, an improvement proposal for a work environment, and the like are extracted. For example, feedback from a site such as “an arm replacement procedure of an I robot is difficult to understand”, “wanting a work video of a J task to be distributed to a site”, and “caution because a grease replacement timing of a K robot is near” is also recorded in detail. Specifically, the system executes an advanced natural language processing pipeline in the communication log management unit. The system implements a large language model and a bidirectional encoder representations model. When receiving voice data, the system executes a text conversion process using an acoustic model and a language model. The system converts text data into a word embedding vector. The system inputs a token sequence of text and a mel-spectrogram of voice to the model. The system executes preprocessing such as removal of a stop word and stemming before input. For example, the system configures a text sequence of 512 tokens as an input tensor. The model extracts context information from input data and outputs an intent classification label and an entity extraction result. For example, the model outputs a category label of an abnormality report as an intent. The model extracts character string data such as the robot C and an arm joint as an entity. The system stores the extracted entity in a structured database. The system relationally links the stored data with data of the task management unit and the robot management unit. The system converts unstructured data into structured data by these processes. The system immediately reflects feedback of a site to the entire system. The system eliminates a delay and an error due to manual input by a human. The system calculates semantic similarity of text in a high-dimensional vector space. The system instantaneously searches and presents a past similar trouble report. The system uses a masked language modeling method in learning of the model. The system adapts a technical term peculiar to a site to the model by fine-tuning. The system dramatically improves efficiency of data management by these technical processes.

The AI integration unit inputs all information collected from the robot management unit, the task management unit, and the communication log management unit to the generative AI, and analyzes the information comprehensively and in a multivariate manner. The AI integration unit comprehensively analyzes a progress status and a dependency relationship of a task, an operating state and a workload of a robot, a necessity of maintenance, an abnormality occurrence status, a maintenance history, a state of a consumable part, an abnormality report and a request from a field worker, work environment data, a quality inspection result, a past trouble history, and the like, and automatically extracts a bottleneck and a risk of the entire production line. For example, when a “welding” task is unstarted due to a delay of an “assembly” task, the AI integration unit proposes progress acceleration of the “assembly” task and an increase in assigned robots. When a robot B is in an abnormal state and has a workload of 95%, the AI integration unit recommends inspection, temporary suspension, and task reallocation to another robot. When an “inspection” task requires maintenance, the AI integration unit recommends maintenance execution of an assigned robot and schedule adjustment. When a deterioration degree of a consumable part exceeds a threshold value, the AI integration unit proposes part replacement and preventive maintenance. Furthermore, while referring to a solution example of a past similar project and an external best practice, the AI integration unit can make a more advanced improvement proposal by utilizing knowledge such as “when a similar abnormal stop occurred in the past, it was solved by arm replacement and an update of control software”, “at the time of a delay of a plurality of tasks, a delivery time was shortened by task division and addition of an assigned robot”, and “when rejected products frequently occurred in a quality inspection, it was improved by review of a work procedure and worker education”. In addition, the AI integration unit can also execute automatic resetting of a priority and a deadline of a task, automatic allocation of an assigned robot, automatic alert issuing at the time of a progress delay, automatic escalation at the time of risk occurrence, automatic generation of a maintenance plan, a real-time notification to a field worker, automatic distribution of a work procedure, automatic feedback at the time of a quality abnormality, and the like. Specifically, the system adopts a multimodal architecture in the AI integration unit. The system projects heterogeneous data into the same latent space. The system combines a time-series sensor tensor of a robot, graph structure data of a task, and an embedding vector of a communication log. The system inputs the combined multidimensional tensor to a generative AI model. The system calculates a mutual relationship between respective data modalities using a cross-attention mechanism. For example, the system calculates an attention weight between an abnormal value of sensor data and a dissatisfaction expression of a text log. The model outputs an identification probability of a bottleneck node of the entire production line and a risk score. The model outputs a recommended action as a text generation token sequence. For example, the model outputs a delay probability of a welding task as 0.88. The model outputs a command character string instructing an increase in assigned robots. The system verifies the generated action plan by a rule-based constraint checker. The system converts the plan that has passed the verification into an executable control command group. The system realizes data fusion of a plurality of domains by these processes. The system identifies a complex risk factor exceeding a human cognitive limit. The system generates an explanatory text in a natural language using an autoregressive decoder. The system uses a beam search algorithm to evaluate validity of the generated text. The system acquires a past solution example from a vector database by similarity search. The system applies a retrieval-augmented generation method of adding a search result as a context of a prompt. The system dramatically improves inference accuracy by these technical processes.

The user interface unit provides a screen and a dashboard on which a field worker and an administrator can view and operate task information, a robot state, a proposal by an AI, an alert, a communication log, a quality inspection result, work environment data, and the like in real time. For example, a progress status of a task is displayed in a Gantt chart or Kanban board format, and allocation of an assigned robot and a work location can be changed by drag and drop. An improvement proposal and an action plan generated by the AI can be approved or rejected with one click, and the approved proposal is automatically reflected in the entire system. A field worker can immediately input an abnormality report and a work request from a tablet terminal or a smartphone, and can also receive an automatic reply and FAQ presentation by the AI. Specifically, the system executes a high-speed drawing process on a browser in the user interface unit. The system receives update data in real time from a back-end server via a bidirectional communication protocol. The system reflects the received data on a virtual document object model. The system renders an attention weight as a heat map on a screen in order to visualize an inference basis of the AI. The system acquires tap coordinates and a swipe trajectory vector from a user as input data. The system executes a smoothing process and noise removal on input data. For example, the system acquires a trajectory of a drag operation on a specific task node on a screen as a two-dimensional vector sequence. The system generates a redrawing command of a UI component based on input data. The system outputs an API request for state update to a back end. For example, the system outputs a JSON payload instructing a change of an assigned robot of a task. The system accumulates an operation history of a user as a reward signal of a reinforcement learning model. The system gives a positive reward when the user approves the proposal of the AI, and gives a negative reward when the user rejects the proposal. The system fine-tunes a weight parameter of a proposal model using this reward signal. The system provides intuitive operability by these processes. The system realizes speeding up of decision making. The system not only displays information but also learns an implicit intention of a user from an operation log. The system offloads a rendering process of a screen to a graphics processing unit to reduce a load on a main processor. The system significantly improves a response speed of the system by these technical processes.

The data linkage unit performs API and database linkage with various sensors, a robot controller, an MES, an ERP, a quality management system, an inventory management system, an external cloud service, and the like in a factory, and acquires and integrates necessary data in real time. For example, the data linkage unit directly acquires operation data and an error code of a robot from a controller, receives pass/fail determination data from a quality inspection system, acquires a part inventory status from an inventory management system, and acquires a production plan and progress data from an MES. Thereby, consistent information management and optimization become possible in the entire system. Specifically, the system establishes asynchronous communication using a message queuing protocol in the data linkage unit. The system buffers streaming data from an edge device in an in-memory database. The system implements a data cleansing processing unit. The system automatically executes interpolation of a missing value and removal of an outlier. The system receives raw data of a heterogeneous format as input data. The system acquires an XML format, a CSV format, and a binary payload as input data. The system executes schema verification and a type conversion process on input data. For example, the system parses unique binary data transmitted from a robot controller. The system generates an object of a normalized common schema as output data. For example, the system outputs all data as a key-value format data structure having a unified time stamp and identifier. The system distributedly writes the normalized data to a database of each management unit. The system guarantees data consistency using a distributed transaction management mechanism. The system reduces a degree of coupling between systems by these processes. The system improves scalability. The system maximizes throughput by distributing a data conversion process to parallel worker processes. The system detects reversal and duplication of an arrival order of data and automatically corrects them. Even when an instantaneous interruption of a network occurs, the system holds data using a local cache and retransmits the data at the time of reconnection. The system reduces a communication load and enhances robustness of the system by these technical processes.

As a specific example of a prompt sentence to be read by the generative AI when implementing the present invention, there is given “Please analyze the following robot information, task information, communication log, quality inspection result, and work environment data, identify a bottleneck and a risk of a production line, and generate an optimal robot allocation, maintenance plan, and work procedure improvement proposal. Robot information: A, normal, 80%, 2024-06-01, arm wear 70%; B, abnormal, 95%, 2024-06-01, motor temperature rise; C, normal, 60%, 2024-06-01, remaining battery level 60%. Task information: assembly, A, completed; welding, B, in progress, dependency: assembly; inspection, C, unstarted, dependency: welding, maintenance required. Communication log: B robot abnormality report from a site, C task work procedure unclear point report. Quality inspection result: frequent occurrence of rejected products in welding task. Work environment data: welding process temperature 35 degrees, humidity 80%.” and the like. Furthermore, an advanced prompt such as “Please compare a past project history and a current task progress, predict a risk that may occur in the future, and present a countermeasure proposal.” can also be utilized. Specifically, the system includes a prompt generation module configured to automate prompt engineering. The system dynamically embeds a latest status value acquired from a structured database into a template. The system acquires a current state vector of a robot, a progress rate scalar value of a task, and numerical data of an environmental sensor as input data. The system executes format conversion and filtering based on importance on the input data. For example, the system preferentially extracts data of a robot in an abnormal state and converts the data into text. The system generates a prompt character string with a context interpretable by a large language model as output data. For example, the system outputs a character string including a detailed situation explanation and an instruction extending to thousands of tokens. The system transmits the generated prompt to an inference interface of the large language model. The system receives a response text from the model and passes the response text to a subsequent syntax analysis module. The system realizes automation of prompt generation by these processes. The system reduces a processing delay. The system suppresses hallucination of the AI by accurate transmission of the context. The system applies an automatic summarization algorithm in order to keep a length of the prompt within the maximum number of input tokens of the model. The system learns a structure of a prompt that succeeded in the past and dynamically selects an optimal prompt template. The system calculates an embedding vector of the generated prompt and evaluates a similarity with a past prompt. The system dramatically improves stability and accuracy of inference by these technical processes.

In this way, the system according to the present embodiment includes a robot management unit, a task management unit, a communication log management unit, an AI integration unit, a user interface unit, and a data linkage unit, and each unit cooperates to centrally manage and analyze a robot in a factory, a production task, communication of a field worker, a work environment, and quality information in real time, and realizes advanced optimization and decision-making support using a generative AI. Specifically, the system adopts a hybrid configuration of an edge computing node and a cloud server. The system executes a lightweight inference model on an edge side. The system executes a large-scale learning process on a cloud side. The system updates a weight of a model without sharing data between a plurality of factories by using a federated learning method. The system transmits a gradient vector calculated at each edge node to the cloud server as input data. The system executes an encryption process and addition of differential privacy on the input data. For example, the system superimposes Laplace noise on a gradient vector of millions of dimensions and transmits the gradient vector. The system generates a weight parameter of a global model aggregated in the cloud server as output data. For example, the system calculates an average value of gradients from each node and outputs a new weight matrix. The system distributes the updated weight to each edge node. The system synchronizes the inference model on the edge side. The system significantly saves a communication band by these processes. The system protects privacy of confidential data. The system continuously improves inference accuracy of the entire system. The system dynamically executes quantization and pruning of the model according to a calculation resource of the edge node. The system completes an inference process near a generation source of data in order to minimize a network delay. The system realizes advanced optimization while ensuring real-time performance by these technical processes.

### Implementation Steps

Step 1: Registration and management of robot and task information. For all robots operating in a factory, a robot ID, an operating state, a workload, a last maintenance date, an abnormality occurrence history, an operating time, an assigned task, a maintenance history, a state of a consumable part, a motor temperature, a remaining battery level, a grease replacement timing, a calibration history of a sensor, a history of an error code, and the like are registered in detail and managed in chronological order. In addition, for all production tasks, a task name, an assigned robot, a deadline, a progress status, a dependency relationship, a priority, a required resource, a progress rate, a related document, a necessity of maintenance, a past history, a comment, tagging information, a work location, a quality inspection result, work environment data, and the like are registered and managed in detail. Addition, editing, and deletion of a task, an assignment change of an assigned robot, adjustment of a deadline, an update of a progress rate, setting and change of a dependency relationship, an inventory status of a necessary jig, tool, and part, assignment of a work location, pass/fail judgment of a quality inspection, and recording of a work environment are also performed in real time. Specifically, the system executes a process of writing initial data to a distributed database in this step. The system constructs a digital twin of each robot in a virtual space. The system acquires a specification parameter and an initial state vector of a robot as input data. The system executes a consistency check and an initialization routine on the input data. For example, the system inputs a static parameter such as a maximum payload of a robot and a degree of freedom of an arm as a vector. The system generates a digital twin object to which a unique identifier is assigned as output data. For example, the system outputs an object instance encapsulating a state of a robot on a memory. The system subscribes to a state change event. Every time sensor data from a physical robot is received, the system updates a property of the digital twin in real time. The system realizes complete synchronization between a physical entity and a virtual entity by these processes. The system improves accuracy of a simulation. The system stores a dependency relationship of a task in a graph database to enable a high-speed route search. The system utilizes an in-memory cache to shorten a read delay of frequently accessed state data to a millisecond unit. The system performs version management of data to enable restoration of a state at an arbitrary point in time in the past. The system achieves both robustness of data management and an access speed by these technical processes.
Step 2: Collection of communication log and field data. Various communication data such as a meeting, a chat, a voice call, an email, and an SNS with a field worker are automatically acquired and accumulated in chronological order. When a field worker inputs an abnormality report, a work request, an unclear point of a work procedure, a congestion status of a work location, a sensor abnormality, frequent occurrence of rejected products in a quality inspection, and the like from a tablet terminal or a smartphone, these pieces of information are recorded as a communication log. Meeting voice data is converted into text by a voice recognition engine, and utterance contents and frequency for each speaker are also analyzed. From contents of a chat and an email, an abnormality report, a work instruction, a maintenance request, a progress report, raising of an issue, an intention indication of approval or rejection, a remark regarding a risk, an improvement request for a work procedure, a progress of troubleshooting at a site, know-how sharing between workers, an improvement proposal for a work environment, and the like are extracted. Specifically, the system executes a multi-channel data ingestion pipeline in this step. The system applies a noise canceling process and speaker diarization to voice data. The system acquires voice waveform data with a sampling rate of 16 kHz as input data. The system executes a short-time Fourier transform on the input data and extracts a feature amount in a frequency domain. For example, the system inputs a voice signal as a matrix of Mel-frequency cepstral coefficients. The system generates a text token sequence to which a speaker identifier and a time stamp are assigned as output data. For example, the system outputs a text of an abnormality report uttered by a speaker A at a time T. The system inputs text data to an emotion analysis model. The system quantifies and outputs a fatigue degree and a stress level of a worker. The system formalizes tacit knowledge of a site by these processes. The system advances safety management of a worker. The system automatically tags an equipment name and a part name from text data of a chat by using a named entity extraction model. The system structures the extracted information as a knowledge graph. The system processes a large amount of log data in real time by using a stream processing engine. The system dramatically improves information extraction efficiency from unstructured data by these technical processes.
Step 3: Integrated analysis and bottleneck/risk extraction by generative AI. All information collected from the robot management unit, the task management unit, and the communication log management unit is input to the generative AI, and is analyzed in an integrated and multivariate manner. The generative AI comprehensively analyzes a progress status and a dependency relationship of a task, an operating state and a workload of a robot, a necessity of maintenance, an abnormality occurrence status, a maintenance history, a state of a consumable part, an abnormality report and a request from a field worker, work environment data, a quality inspection result, a past trouble history, and the like, and automatically extracts a bottleneck and a risk of an entire production line. As a specific example of a prompt sentence to be read by the generative AI, there is given “Please analyze the following robot information, task information, communication log, quality inspection result, and work environment data, identify a bottleneck and a risk of a production line, and generate an optimal robot allocation, maintenance plan, and work procedure improvement proposal. Robot information: A, normal, 80%, 2024-06-01, arm wear 70%; B, abnormal, 95%, 2024-06-01, motor temperature rise; C, normal, 60%, 2024-06-01, remaining battery level 60%. Task information: assembly, A, completed; welding, B, in progress, dependency: assembly; inspection, C, unstarted, dependency: welding, maintenance required. Communication log: B robot abnormality report from a site, C task work procedure unclear point report. Quality inspection result: frequent occurrence of rejected products in welding task. Work environment data: welding process temperature 35 degrees, humidity 80%.” and the like. Specifically, the system drives a deep learning model equipped with a self-attention mechanism in this step. The system converts heterogeneous data into a common embedding dimension. The system generates a feature amount matrix. The system acquires a combined tensor of a robot state vector, a task graph matrix, and a text embedding vector as input data. The system adds positional encoding to the input data. For example, the system maps data from three different modalities to a 512-dimensional common vector space and inputs the data. The system generates a predicted value of a delay occurrence probability and a contribution score of a risk factor in each production process as output data. For example, the system outputs a delay probability of a welding process as 0.95. The system outputs a contribution degree of a motor temperature rise as 0.72. The system extracts a factor whose contribution score exceeds a predetermined threshold value. The system passes the extracted factor to an alert generation module. The system elucidates a complex causal relationship by these processes. The system discovers a potential risk at an early stage. The system simultaneously learns feature representations from different viewpoints by using multi-head attention. The system applies a residual connection and layer normalization in order to prevent a vanishing gradient problem. The system significantly improves learning efficiency and inference accuracy of the model by these technical processes.
Step 4: Automatic generation of improvement proposal and action plan by generative AI. The generative AI automatically generates a specific improvement proposal and an action plan for the extracted bottleneck and risk while referring to a solution example of a past similar project and an external best practice. For example, the generative AI generates various proposals according to a situation of a site, such as “progress acceleration of an assembly task and an increase in assigned robots”, “inspection and temporary suspension of an abnormal robot, and task reallocation to another robot”, “maintenance execution and schedule adjustment of an assigned robot for a task requiring maintenance”, “replacement of a consumable part and preventive maintenance”, and “work environment adjustment and work procedure re-education when rejected products frequently occur in a quality inspection”. As a specific example of a prompt sentence to be read by the generative AI, there is given “Please generate an optimal improvement proposal and action plan with reference to the following bottleneck/risk information and past solution examples. Bottleneck: welding task delay, B robot abnormality, C task work procedure unclear point. Past example: solved by increasing assigned robots when welding task is delayed, solved by part replacement and control software update when robot is abnormal.” and the like. Specifically, the system executes a reinforcement learning-based planning algorithm in this step. The system searches for an optimal action policy based on a Markov decision process. The system acquires a current system state vector and an extracted risk factor vector as input data. The system executes discretization or dimensionality reduction of a state space on the input data. For example, the system inputs a current state of a production line as a 256-dimensional state vector. The system generates a series of control command sequences and an optimization matrix of resource reallocation as output data. For example, the system outputs a command group for stopping a robot B and transferring a task to a robot C. The system pre-evaluates the generated plan on an internal physical simulator. The system selects a plan that maximizes an expected reward and shifts to execution. The system realizes automation of trial and error by these processes. The system derives an optimal solution and avoids downtime. The system simultaneously learns a policy function and a value function by using an actor-critic method. The system applies an epsilon-greedy method in order to optimize a trade-off between exploration and exploitation. The system accumulates a past success example in an experience replay buffer and enhances stability of learning. The system dramatically improves adaptability to a dynamic environmental change by these technical processes.
Step 5: Confirmation of proposal and summary by user and reflection on site. In the user interface unit, an administrator and a field worker confirm an improvement proposal, an action plan, a summary, an unresolved issue list, and the like generated by the AI, and perform approval, rejection, correction, and supplementation as necessary. The approved proposal and action plan are automatically reflected in the robot management unit, the task management unit, a notification to a field worker, a maintenance plan, work procedure distribution, feedback to a quality management system, and the like. The field worker can immediately confirm the AI proposal from a tablet terminal or a smartphone, and rapid decision-making and response at a work site become possible. Specifically, the system provides a human-in-the-loop mechanism in this step. The system acquires an approval or correction operation of a user as a feedback signal. The system acquires an index of an action selected by a user and a parameter value input for correction as input data. The system executes noise removal and outlier detection on the input data. For example, the system receives a numerical value obtained by correcting a proposed parameter value by 10% by a user as an input. The system generates a teacher data pair for fine-tuning of a model as output data. For example, the system outputs a pair of a state vector of the system and an optimal action vector finally selected by a user. The system fine-tunes a weight parameter of a generative AI model by using this teacher data. The system improves proposal accuracy of next time. The system realizes autonomous learning and evolution of the system by these processes. The system adapts the model to a unique operation rule and constraint condition of a site. The system updates the model in real time by using an online learning algorithm. The system learns new data while retaining an important data point in the past in order to prevent catastrophic forgetting. The system highly fuses human expertise and computing power of a computer by these technical processes.

### Specific Use Case

For example, in a factory including an assembly process of an automobile part, a plurality of robots share processes such as “assembly”, “welding”, “inspection”, and “packaging”, and an operating state, a workload, a last maintenance date, a wear degree of a consumable part, an abnormality occurrence history, an assigned task, a maintenance history, a remaining battery level, a motor temperature, a grease replacement timing, a sensor calibration history, an error code history, and the like of each robot are centrally recorded and managed by the robot management unit. For each production task, a task name, an assigned robot, a deadline, a progress status, a dependency relationship, a priority, a required resource, a progress rate, a related document, a necessity of maintenance, a work location, a quality inspection result, work environment data, and the like are managed in detail by the task management unit. For example, a “welding” task has completion of an “assembly” task as a dependency condition, is assigned to a robot B, has a progress rate of 60%, and is linked with a quality inspection standard document and a work procedure manual. A field worker inputs an abnormality report and a request such as “operation of robot B is unstable”, “there is an unclear point in a procedure of an inspection task”, and “a work location is congested in a packaging process” to the communication log management unit from a tablet terminal. Meeting voice data and a chat history are also automatically acquired, and an abnormality report, a work instruction, a maintenance request, a progress report, raising of an issue, approval or rejection, a risk remark, an improvement request for a work procedure, field know-how sharing, an improvement proposal for a work environment, and the like are extracted. Specifically, the system integrates an image recognition process using an edge AI camera in this use case. The system analyzes a video of an assembly process in real time. The system detects a delay and an abnormality of work. The system acquires a continuous tensor of RGB image frames with a resolution of 1920 by 1080 as input data. The system executes resizing, normalization, and color space conversion on the input data. For example, the system inputs a moving image of 30 frames per second as a three-dimensional tensor to a convolutional neural network. The system generates posture estimation coordinates of a robot, bounding box coordinates of a part, and an abnormality detection flag as output data. For example, the system outputs a flag indicating a missing part as true. The system immediately transmits an interrupt signal to the task management unit when the abnormality detection flag is true. The system realizes automation of a visual inspection by these processes. The system aims at uniformization of quality. The system enables an immediate response when an abnormality occurs. The system adopts a single-shot detector such as YOLO and SSD as an object detection algorithm to minimize an inference delay. The system calculates an optical flow to track a trajectory of a dynamic object. The system imparts advanced situation recognition based on visual information to a computer by these technical processes.

The AI integration unit inputs information obtained from the robot management unit, the task management unit, and the communication log management unit into the generative AI, and comprehensively analyzes these when, for example, a “welding” task is unstarted due to a delay of an “assembly” task, an “inspection” task requires maintenance, “robot B” is in an abnormal state and has a workload of 95%, a remaining battery level is decreasing, a motor temperature is in a rising trend, a grease replacement time is approaching, an abnormal stop of the same part has occurred a plurality of times in the past year, and there is a report from a field worker that “rejected products frequently occur in a quality inspection of a welding process”. The generative AI specifically proposes progress acceleration of the “assembly” task, an increase in assigned robots, inspection, temporary suspension, part replacement, and control software update of “robot B”, reassignment of an assigned robot and execution of maintenance for the “inspection” task, adjustment of a work environment (temperature and humidity), retraining of a work procedure, feedback to a quality management system, and the like. Furthermore, by referring to a past project history and an external best practice, the generative AI utilizes knowledge such as “solved by arm replacement and control software update at the time of a similar abnormal stop” and “improved by work environment adjustment and worker education at the time of frequent occurrence of quality inspection rejections”, for example, and generates an optimal action plan. Specifically, the system optimizes a cooperative operation of a plurality of robots by using multi-agent reinforcement learning. The system models each robot as an independent agent. The system acquires a local observation vector of each agent as input data. The system acquires a distance to a surrounding obstacle, its own remaining battery level, and current position coordinates as the input data. For example, the system converts point cloud data from a laser scanner into a one-dimensional vector and inputs the one-dimensional vector. The system generates a next action vector of each agent as output data. For example, the system outputs an angle of a moving direction, a traveling speed, and a target angle of each joint of an arm as a numerical vector. The system transmits the action vector to a robot controller. The system drives a physical actuator. The system improves adaptability to a dynamic environmental change by these processes. The system realizes a totally optimized production line. The system adopts a paradigm of centralized learning and decentralized execution. The system shares states of all agents and updates a value function at the time of learning. The system causes each agent to autonomously determine an action based only on its own observation at the time of execution. The system realizes robust multi-robot control unaffected by a communication delay by these technical processes.

Specific examples of a prompt sentence to be read by the generative AI include “Please analyze the following robot information, task information, communication log, quality inspection result, and work environment data, identify a bottleneck and a risk of a production line, and generate optimal robot allocation, a maintenance plan, and an improvement proposal for a work procedure. Robot information: A, normal, 80%, 2024-06-01, arm wear 70%; B, abnormal, 95%, 2024-06-01, motor temperature rise; C, normal, 60%, 2024-06-01, remaining battery level 60%. Task information: assembly, A, completed; welding, B, in progress, dependency: assembly; inspection, C, unstarted, dependency: welding, maintenance required. Communication log: B robot abnormality report from site, C task work procedure unclear point report. Quality inspection result: frequent occurrence of rejected products in welding task. Work environment data: welding process temperature 35 degrees, humidity 80%.” and the like. Specifically, the system includes a summarization module for optimizing the number of tokens of the prompt. The system avoids an input context length limitation of a large language model. The system filters information with low importance. The system acquires a raw log data character string and a search result of a past history database as input data. The system applies an important sentence extraction algorithm by natural language processing to the input data. For example, the system extracts a keyword by using a TF-IDF score and a TextRank algorithm. The system generates a compressed prompt character string in which information entropy is maximized as output data. For example, the system outputs a summary sentence compressed to one-thirtieth of a length of an original text. The system inputs the compressed prompt to an inference engine. The system parses generated text and returns the generated text to structured data. The system reduces an inference cost by these processes. The system reduces an API communication amount. The system improves a response speed. The system uses a rule-based protection mechanism in combination so that important numerical data and an identifier are not lost in a compression process of the prompt. The system brings out maximum inference performance with limited calculation resources by these technical processes.

In this way, the system of the present invention centrally manages and analyzes robots, tasks, communication of field workers, quality information, and work environment data in a factory in real time, and comprehensively realizes optimization of an entire production line, automatic extraction of a bottleneck and a risk, optimal robot allocation and a maintenance plan, an improvement proposal for a work procedure, an alert notification to a site, automatic feedback at the time of a quality abnormality, and the like by using the generative AI. Specifically, the system functions as a core of a cyber-physical system. The system establishes closed-loop control that feeds back a simulation result in a virtual space to a physical space in real time. The system acquires multidimensional sensor stream data from the physical space as input data. The system executes state estimation using a Kalman filter on the input data. For example, the system estimates a true position and speed of a robot from a sensor value including noise and inputs the true position and speed. The system generates a synchronized control command group for a robot group in the physical space as output data. For example, the system outputs a trajectory tracking command synchronized in units of milliseconds to a plurality of robots. The system acquires a state change after control execution again by a sensor. The system calculates an error function between a predicted value and an actually measured value. The system continuously updates a parameter of an internal model by using this error. The system realizes complete visualization and control of a production process by these processes. The system constructs an ultimate smart factory. The system calculates a future state transition probability by a Monte Carlo simulation on a digital twin. The system achieves extremely stable autonomous control in a highly uncertain real environment by these technical processes.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

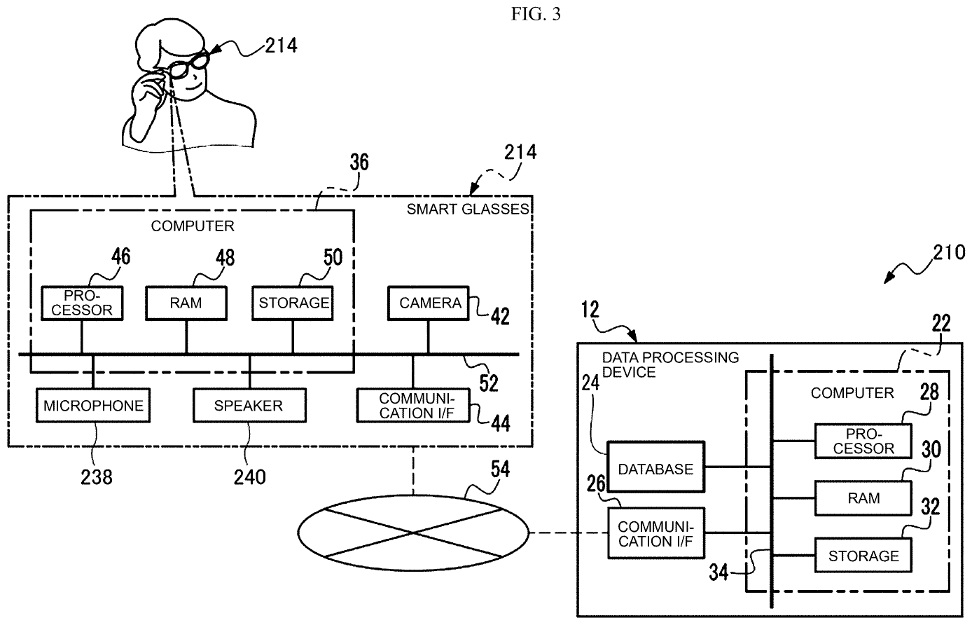

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

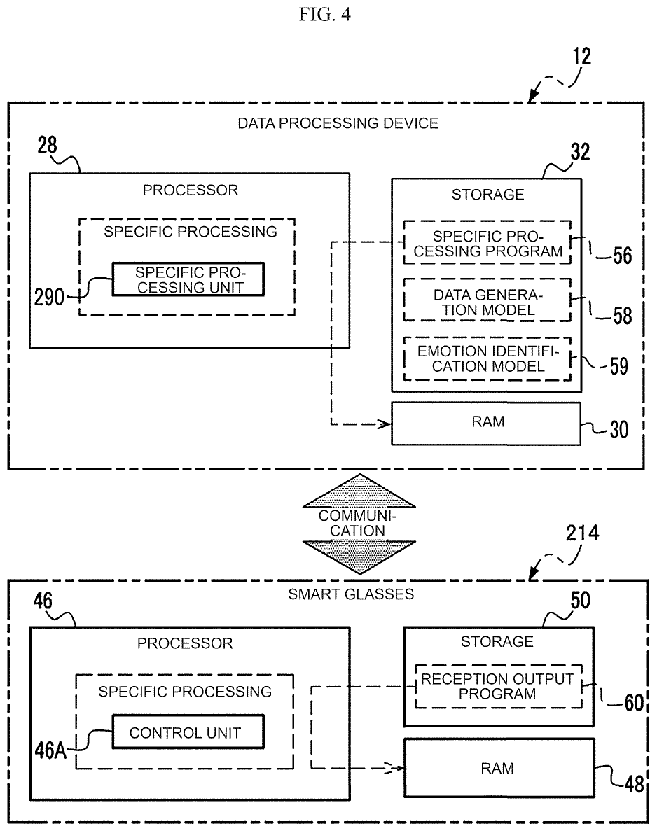

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

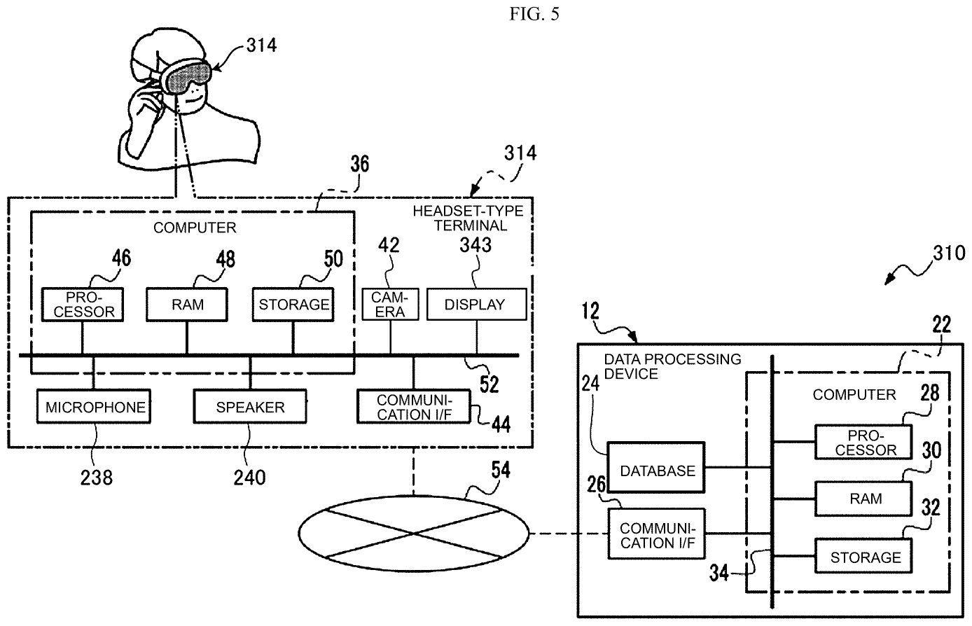

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

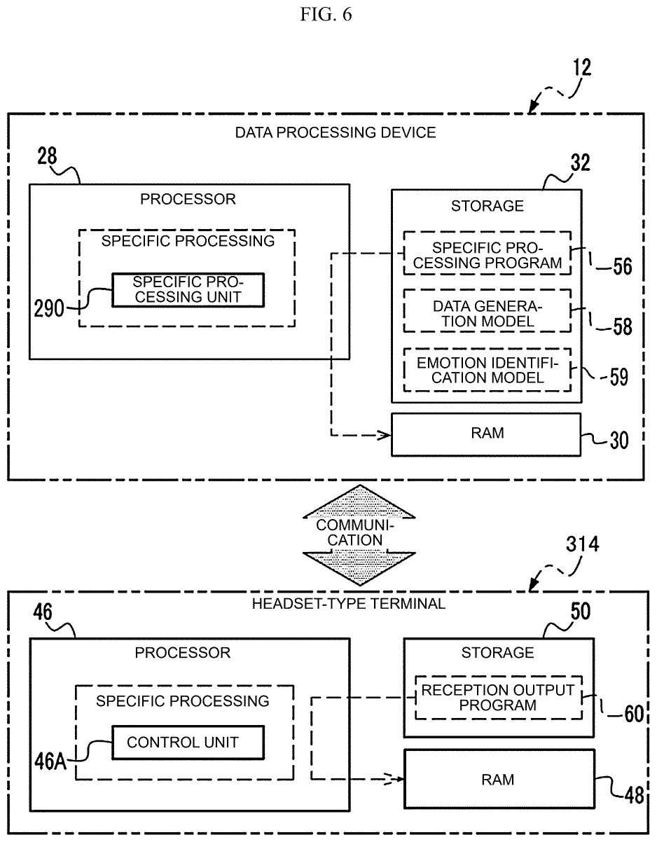

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

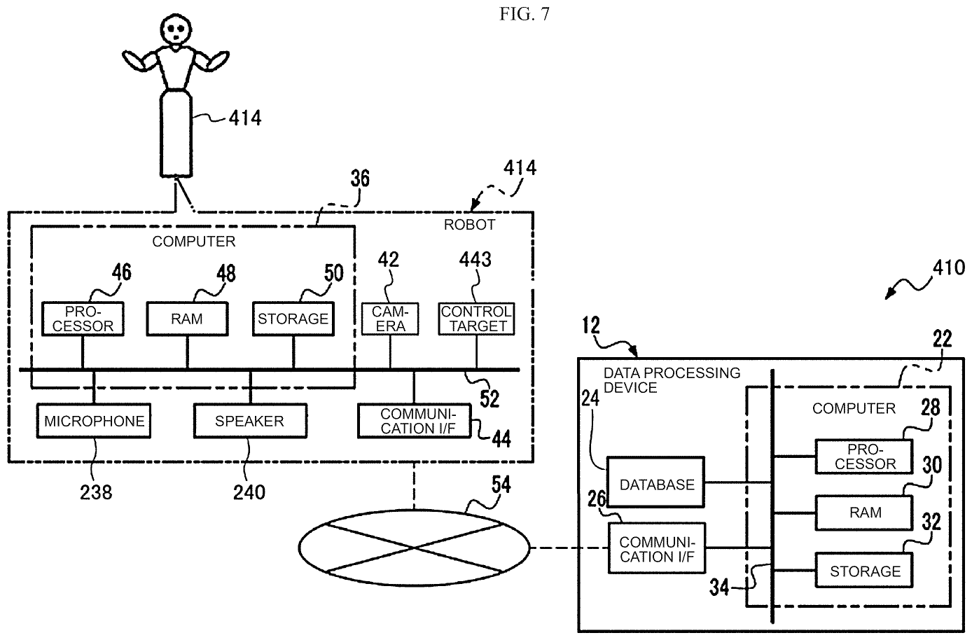

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

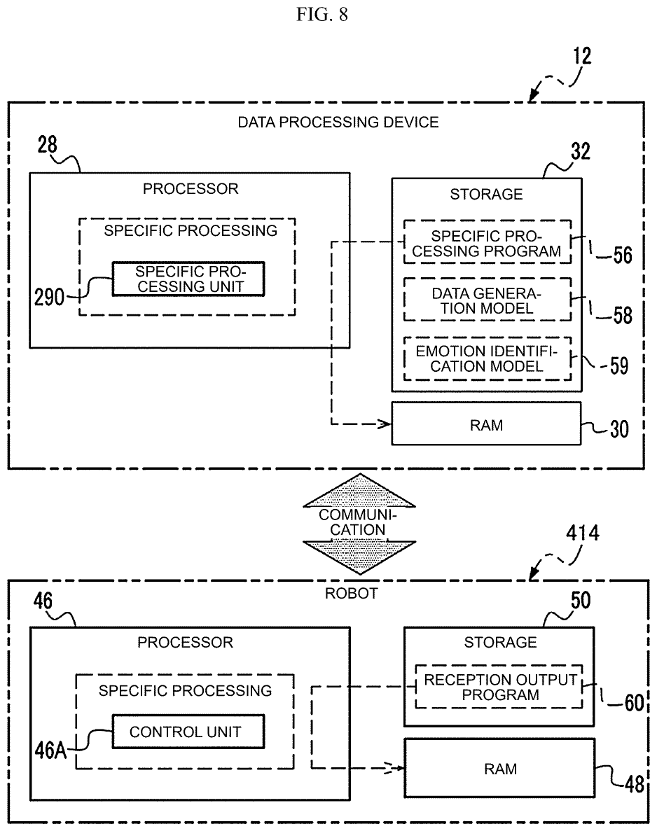

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

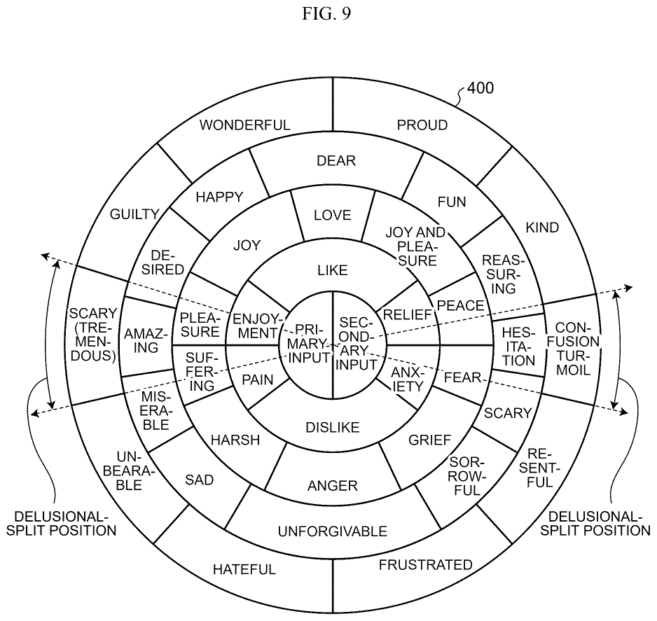

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

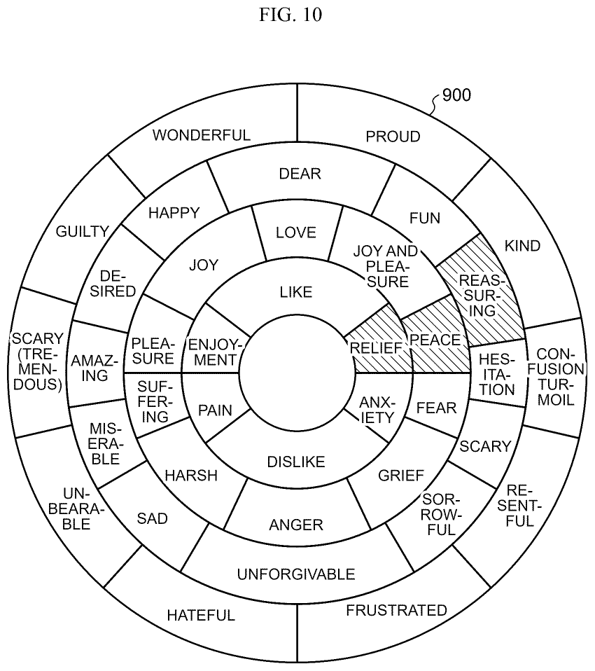

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A system comprising: a robot management unit; a task management unit; and an AI integration unit, wherein the robot management unit stores and manages detailed information such as a robot ID, an operating state, a workload, a last maintenance date, an abnormality occurrence history, an operating time, an assigned task, a maintenance history, and a state of a consumable part for a plurality of robots operating in a factory; the task management unit stores and manages a task name, an assigned robot, a deadline, a progress status, a dependency relationship, a priority, a required resource, a progress rate, a related document, a necessity of maintenance, a past history, a comment, tagging information, and the like for each production task, and further monitors a dependency relationship and a progress status between tasks, an operating status of a robot, and resource allocation in real time; and the AI integration unit comprehensively analyzes information obtained from the robot management unit and the task management unit by using a generative AI, analyzes a progress status of an entire production line, a dependency relationship between tasks, an operating state of each robot, a workload, a necessity of maintenance, an abnormality occurrence status, a maintenance history, progress of an assigned task, a communication log with a field worker, and the like in a multivariate manner, automatically extracts a production bottleneck due to an uncompleted dependent task and a risk such as a robot abnormality, an overload, a maintenance deadline excess, and deterioration of a consumable part, and executes a specific improvement proposal for these, optimization of robot allocation, automatic generation of a maintenance plan, an improvement plan for a work procedure, an alert notification to a site, and presentation of these pieces of information to a user.

### Supplementary Note 2

The system according to Supplementary Note 1, wherein, by using the generative AI, the system comprehensively analyzes information such as an operating state, a workload, an abnormality occurrence history, a last maintenance date, a state of a consumable part, an assigned task, and a maintenance history of each robot stored by the robot management unit, and information such as a progress status, a dependency relationship, a priority, a deadline, a necessity of maintenance, an assigned robot, a progress rate, a comment, and a related document of each production task stored by the task management unit, automatically extracts a task serving as a bottleneck hindering progression of an entire production line and a risk such as a robot abnormality, an overload, a maintenance deadline excess, deterioration of a consumable part, a task delay, and a necessity of maintenance, further generates a specific improvement proposal such as reallocation of an assigned robot, priority change of the task, automatic generation of a maintenance plan, improvement of a work procedure, and an alert notification to a field worker according to factors thereof, and presents the specific improvement proposal to the user.

### Supplementary Note 3

The system according to Supplementary Note 1, wherein, by using the generative AI, the system analyzes a communication log with a field worker and communication data such as a meeting, a chat, and a voice call, automatically extracts an abnormality report, a work instruction, a maintenance request, a progress report, raising of an issue, an intention indication of approval or rejection, a remark regarding a risk, an improvement request for a work procedure, and the like from a site, links these pieces of information with data of the robot management unit and the task management unit, detects a situation change and a risk sign of the site in real time by using the generative AI, and automatically proposes and executes an allocation change of a task or a robot, correction of a maintenance plan, an alert notification, optimization of a work procedure, and the like as necessary.

What is claimed is:

1. A system comprising:
circuitry configured to:
receive, via a communication interface coupled to a packet-switched network, task state data records and communication session data from a terminal device, the task state data records comprising task identifiers, temporal constraint parameters, dependency relationship data, and progress state indicators, and store the task state data records and communication session data in a storage device;
process the communication session data using a speech recognition model and a natural language processing model to extract key token sequences, outcome classification data, and unresolved item indicators;
analyze the task state data records, the dependency relationship data, and the key token sequences using a generative neural network model comprising a multimodal encoder architecture to generate a constraint node prediction vector identifying task identifiers associated with scheduling conflicts and a risk probability score for each identified task identifier;
generate optimization action sequences corresponding to the constraint node prediction vector, the optimization action sequences comprising task parameter adjustment instructions and resource reallocation recommendations; and
transmit the constraint node prediction vector, the optimization action sequences, and a session summary generated from the key token sequences and the outcome classification data to the terminal device via the communication interface.

2. The system according to claim 1, wherein the circuitry is configured to receive telemetry data from sensor devices via the communication interface, parse the telemetry data to extract multidimensional numerical parameter arrays, expand the extracted numerical parameter arrays in memory as time-series arrays, and extract trend components from continuous value parameters using a moving average filter.

3. The system according to claim 2, wherein the circuitry is configured to apply an anomaly detection model to the time-series arrays to compute reconstruction error scores by comparing predicted values against observed sensor values, generate an anomaly signal when a reconstruction error score exceeds an anomaly threshold parameter, and incorporate the anomaly signal as an additional indicator in the task state data records.

4. The system according to claim 3, wherein the circuitry is configured to store telemetry data and task state data records in a time-series database in the storage device, construct an integrated data warehouse by joining records from the time-series database with the task state data records and the communication session data, and apply the generative neural network model to the integrated data warehouse.

5. The system according to claim 4, wherein the circuitry is configured to construct a digital twin model of a physical system in a virtual environment by mapping telemetry parameter values from sensor devices to corresponding virtual component state variables, update the virtual component state variables in the digital twin model in real time based on received telemetry data, and generate visual state representations of the digital twin model for transmission to the terminal device.

6. The system according to claim 2, wherein the circuitry is configured to apply a one-dimensional convolutional neural network to the time-series arrays to predict a degradation trend metric for each sensor device, and generate a maintenance action item when a predicted degradation trend metric exceeds a degradation threshold parameter derived from the temporal constraint parameters.

7. The system according to claim 1, wherein the circuitry is configured to apply a graph neural network to a dependency relationship graph constructed from the dependency relationship data, the dependency relationship graph comprising task identifier nodes and directed edges representing precedence constraints, and execute message passing operations between adjacent nodes to identify critical path nodes having the highest cumulative constraint scores.

8. The system according to claim 7, wherein the circuitry is configured to generate the constraint node prediction vector by computing a constraint score for each task identifier node based on a product of the risk probability score and a temporal slack value derived from the temporal constraint parameters, and sort the task identifier nodes in descending order of the constraint score.

9. The system according to claim 1, wherein the circuitry is configured to process audio stream data from the terminal device using a speech recognition model to generate a real-time transcript token sequence, apply the natural language processing model to the real-time transcript token sequence to detect topic deviation indicators and unresolved item indicators, and transmit topic redirection prompt data to the terminal device when a topic deviation indicator is detected.

10. The system according to claim 9, wherein the circuitry is configured to apply positional encoding to the real-time transcript token sequence, extract named entity labels comprising participant identifiers and action item identifiers from the transcript token sequence using the natural language processing model, and associate each extracted action item identifier with a task identifier in the task state data records.

11. The system according to claim 1, wherein the circuitry is configured to generate the session summary by applying the generative neural network model to the key token sequences and the outcome classification data, the session summary comprising a structured data object containing outcome classification data fields, action item data fields, and unresolved item data fields formatted as a machine-readable document.

12. The system according to claim 11, wherein the circuitry is configured to automatically generate updated task state data records from the action item data fields in the session summary, assign temporal constraint parameters to each new task state data record derived from deadline references in the action item data fields, and store the updated task state data records in the storage device.

13. The system according to claim 1, wherein the circuitry is configured to apply the multimodal encoder architecture to simultaneously process time-series sensor data arrays, structured task state data, and natural language text data by encoding each input type with a dedicated modality-specific encoder, and integrate the encoded feature vectors in a coupling layer to generate a shared representation vector.

14. The system according to claim 13, wherein the circuitry is configured to generate updated optimization action sequences by re-applying the generative neural network model to an updated shared representation vector computed after executing a subset of the optimization action sequences, and compare the updated constraint node prediction vector with the prior constraint node prediction vector to measure a reduction in constraint scores.

15. The system according to claim 1, wherein the circuitry is configured to receive updated task state data records from the terminal device via the communication interface indicating completion or delay of task identifiers, update the dependency relationship data to reflect the updated progress state indicators, and regenerate the constraint node prediction vector and the optimization action sequences based on the updated dependency relationship data.

16. The system according to claim 1, wherein the circuitry is configured to generate a textual explanation of each optimization action sequence by applying the generative neural network model to the constraint node prediction vector and a context data record comprising historical optimization action sequences and corresponding outcome records, and transmit the textual explanation to the terminal device.

17. The system according to claim 1, wherein the task state data records correspond to production task records for a manufacturing facility, the dependency relationship data represents inter-task precedence constraints among production tasks, and the sensor devices comprise IoT sensors mounted on automated equipment in the manufacturing facility.

18. A system comprising:
circuitry configured to:
receive, via a communication interface coupled to a packet-switched network, task state data records comprising task identifiers, temporal constraint parameters, and dependency relationship data, and communication session audio stream data from a terminal device;
process the communication session audio stream data using a speech recognition model to generate a transcript token sequence, and apply a natural language processing model to the transcript token sequence to extract outcome classification data and unresolved item indicators in real time;
apply a graph neural network to a dependency relationship graph derived from the dependency relationship data to identify critical path nodes and compute constraint scores for each task identifier node;
analyze the task state data records, the constraint scores, and the extracted outcome classification data using a generative neural network model comprising a multimodal encoder architecture to generate a constraint node prediction vector and optimization action sequences; and
transmit the constraint node prediction vector, the optimization action sequences, and a session summary generated from the transcript token sequence to the terminal device via the communication interface.

19. The system according to claim 18, wherein the circuitry is configured to receive updated task state data records from the terminal device after executing a subset of the optimization action sequences, regenerate the constraint node prediction vector based on updated dependency relationship data, and generate additional optimization action sequences when the regenerated constraint node prediction vector identifies new critical path nodes.

20. A method comprising:
receiving, via a communication interface coupled to a packet-switched network, task state data records and communication session data from a terminal device, the task state data records comprising task identifiers, temporal constraint parameters, dependency relationship data, and progress state indicators, and storing the task state data records and communication session data in a storage device;
processing the communication session data using a speech recognition model and a natural language processing model to extract key token sequences, outcome classification data, and unresolved item indicators;
analyzing the task state data records, the dependency relationship data, and the key token sequences using a generative neural network model comprising a multimodal encoder architecture to generate a constraint node prediction vector identifying task identifiers associated with scheduling conflicts and a risk probability score for each identified task identifier;
generating optimization action sequences corresponding to the constraint node prediction vector, the optimization action sequences comprising task parameter adjustment instructions and resource reallocation recommendations; and
transmitting the constraint node prediction vector, the optimization action sequences, and a session summary generated from the key token sequences and the outcome classification data to the terminal device via the communication interface.
